(19) United States
(12) Patent Application Publication
(10) Pub. No.: US 2024/0328840 A1
(43) Pub. Date: Oct. 3, 2024

(54) 3D-PRINTED ARTIFICIAL CILIA ARRAY MECHANOSENSING TOOL

(71) Applicant: VIRGINIA COMMONWEALTH UNIVERSITY, Richmond, VA (US)

(72) Inventors: Philip GLASS, Richmond, VA (US); Daeha JOUNG, Chesterfield, VA (US)

(21) Appl. No.: 18/621,317

(22) Filed: Mar. 29, 2024

Related U.S. Application Data
(60) Provisional application No. 63/456,007, filed on Mar. 31, 2023.

(51) Int. Cl. G01F 1/54; B29C 64/106; B29K 105/16; B29K 507/04; B29L 31/34; B33Y 10/00; B33Y 70/10; B33Y 80/00

(52) U.S. Cl. CPC G01F 1/54; B29C 64/106; B33Y 10/00; B33Y 70/10; B33Y 80/00; B29K 2105/16; B29K 2507/04; B29L 2031/3406

(57) ABSTRACT

Examples include an artificial conductive cilia based sensor having, on a substrate, a conductive pad and a neighbor conductive pad spaced in a direction. A first conductive cilium has a distal end, and a base end conductively secured to the conductive pad, and is particularly structured with bendability and elasticity. A second conductive cilium has a base end conductively secured to the neighbor conductive pad. A terminal is electrically connected to the conductive pad. Another terminal is electrically connected to the neighbor conductive pad. The first conducive cilium, in accordance with the bendability, is bent by a bending force directed in the spacing direction, to a bent state configured to establish a conductive path to the second conductive cilium and via the elasticity, to self-return to a relaxed state configured to terminate the conductive path.

### CROSS-REFERENCE TO RELATED APPLICATIONS

This application claims priority to U.S. Provisional Application 63/456,007 filed Mar. 31, 2023, which is hereby incorporated by reference in its entirety.

### TECHNICAL FIELD

This disclosure generally relates to cilia based detectors and, more particularly, to conductive cilia contact conductance state detectors.

### BACKGROUND

There are known sensing mechanisms that employ cilia in sensing operations. One is piezoresistivity based cilia sensing, wherein flexing, straining, and/or compressing of cilia generates signals. Another is cilia capacitive-change sensing, wherein flexing of cilia varies a spacing between capacitor plates, correspondingly varying the plate arrangements' capacitance. Another uses magnetic cilia structured as polymeric nano-pillars and infused with magnetic nanoparticles. In the magnetic cilia modality pillars are magnetized vertically, which produces a stray field. When the magnetic cilia are within a gas or fluid flow, the forces flex and bend the magnetic cilia, changing the direction of the stray field. Sensing devices detect the change.

These sensing mechanisms, however, have various shortcomings.

Fabrication of magnetic cilia based measurement devices is costly and such devices have complex structures, e.g., bulky magnetosensing layers.

### SUMMARY

A sensor device according to some embodiments includes a first artificial cilium and a second artificial cilium each having a base attached to a conductive support element on the substrate. The sensing cilium, according to various embodiments, comprises an electrically conductive and bendable cilium with a bending characteristic that is readily tunable, and is elastic with a tunable elasticity so as to bend and self-return, enabling novel detection and measurement methods.

According to some embodiments, one of the two sensing cilia forming the pair is a first type sensing cilium, and the sensor device includes a neighboring sensing cilium having a respective base end conductively secured to a conductive neighboring support element that is secured to the substrate. In accordance with some embodiments a neighboring sensing cilium is electrically conductive and is bendable according to lesser bending sensitivity. According to some embodiments the lesser bending sensitivity is configured that, in response to an external reference force acting, in a lateral direction, concurrently on the sensing cilium and the neighboring sensing cilium, the sensing cilium bends to a sensing cilium bent state and the neighboring cilium bends to a neighboring cilium bent state.

An artificial conductive cilia based sensor according to one or more embodiments can include a substrate, a conductive pad and a neighbor conductive pad positioned a spacing distance, in a spacing direction, from the conductive pad, each secured to the substrate. The artificial conductive cilia based sensor can further comprise a first conductive cilium, having a distal end, a base end conductively secured to the conductive pad, configured with a structural elasticity, and can comprise a second conductive cilium, having a respective base end conductively secured to the neighbor conductive pad. The artificial conductive cilia based sensor can further comprise, according to various embodiments, a first terminal, supported on the substrate and electrically connected to the conductive pad, and can include a second terminal, supported on the substrate and electrically connected to the neighbor conductive pad. According to various embodiments, the conductive cilium can be further configured to bend, responsive to receiving a bending force directed in the spacing direction, to a bent state at which the distal end has a conductive path to the second conductive cilium and, responsive to removing said bending force, to return via a force from the structural elasticity to a relaxed shape that substantially reduces or terminates the conductive path.

A method according to one or more embodiments can include steps of printing, on a substrate a conductive pad and a neighbor conductive pad, spaced apart with a spacing direction and spacing distance, a first terminal and a first conductor electrically connected to the first terminal to the conductive pad, and a second terminal and a second conductor electrically connecting the second terminal to the neighbor conductive pad. The method, according to one or more embodiments can also include three-dimensional (3D) vertical printing of a first conductive cilium on the conductive pad and a second conductive cilium on the second conductive pad. The 3D vertical printing can include, in one or more implementations, a solvent casting 3D printing that includes extruding a homogenous paste comprising graphene, polymer, and solvent, through an extrusion tip, while continually elevating the extrusion tip. According to one or more embodiments the solvent casting 3D printing can include a parameter having a first value in the 3D vertical printing the first conductive cilium and a second value in the 3D vertical printing of the second conductive cilium, the first value configured to provide the first conductive cilium a first bending sensitivity and the second value configured to provide the second conductive cilium a second bending sensitivity, lower than the first bending sensitivity.

This Summary identifies example features and aspects and is not an exclusive or exhaustive description of the disclosed subject matter. Whether features or aspects are included in or omitted from this Summary is not intended as indicative of the relative importance of such features or aspects. Additional features are described, explicitly and implicitly, as will be understood by persons of skill in the pertinent arts upon reading the following detailed description and viewing the drawings, which form a part thereof.

### BRIEF DESCRIPTION OF THE DRAWINGS

FIG. 1A shows a three-dimensional (3D) schematic diagram of one structural arrangement for various dual array 3D-printed artificial cilia mechanosensors according to one or more embodiments; FIG. 1B shows a front view of the example arrangement from FIG. 1A projection 1B-1B; FIG. 1C shows, via intermediate top view from FIG. 1A projection 1C-1C an example cilia cross-section and other aspects; and FIG. 1D shows, via top view from FIG. 1A projection 1D-1D, conductive caps according to one or more embodiments;

FIG. 2A shows from FIG. 1A projection one example artificial cilia deflection state and its corresponding cilium-to-cilium conductance state; and FIG. 2B is a top view from FIG. 2A projection 2B-2B showing an example conductive cap surface contact path according to various embodiments;

FIG. 3A shows a 3D schematic diagram of one structural arrangement, in a resting state, of a stepped conductance mechanosensing sensing dual array 3D-printed artificial cilia mechanosensor according to one or more embodiments; FIGS. 3B, 3C, and 3D show, respectively, three deflection states of the FIG. 3A structural arrangement; FIG. 3B showing a force first threshold deflection state, FIG. 3C showing a force second threshold deflection state; and FIG. 3D showing a force third threshold deflection state;

FIG. 4A shows from FIG. 3A projection 4A-4A the distal caps' spacings in the non-conducting default or resting state; FIG. 4B shows from FIG. 3B projection 4B-4B two distal caps pairs' respective spacings and one distal cap pair's surface contact conducting state;

FIG. 4C shows from FIG. 3C projection 4C-4C one distal caps pair's spacing and two distal cap pairs' surface contact conducting state; and FIG. 4D shows from FIG. 3D projection 4D-4D three distal cap pairs' surface contact conducting state;

FIG. 5A shows a 3D schematic diagram of a resting state of one structural arrangement of a single-pair artificial cilia based mechanosensor according to one or more embodiments; and FIG. 5B shows an example deflected state, producing a mechanosensing ON state conductive path;

FIG. 6 shows a logic diagram of one operational flow in accordance with one or more embodiments, in a process for fabricating conductance state based 3D printed artificial cilia sensors according to various such sensor embodiments;

FIGS. 7A-7B show a snapshot image and a subsequent snapshot image, taken from a video capture of a 3D silver epoxy printing, on a substrate surface, of electrodes, cilia coupling supports and connecting traces, in an example process of fabricating one conductance state based 3D printed artificial cilia mechanosensor according to one or more embodiments;

FIG. 8 shows a snapshot image, taken from a video capture of an example 3D solvent cast printing of a conductive artificial cilia, exampling high aspect ratio and a larger bulbous base according to one or more embodiments;

FIG. 9 shows a snapshot image taken from a video capture of a deposition of a dermal layer in accordance with one or more embodiments, to assist holding cilia and without disturbing the electrical pathway;

FIG. 10 shows a snapshot image taken from a video capture of an example adding of conductive distal caps to at least some cilia, for statistical increase, in some applications, of surface contact area and of contact conductance;

FIG. 11 shows an abstracted snapshot state in a 3D solvent cast printing of conductive artificial cilia, annotated to show certain processing reactions, and illustrative of high aspect ratio printing in fabrication according to one or more embodiments;

FIG. 12 shows a photographic capture of the external geometry of three different artificial cilia, each of produced using, in its 3D solvent cast printing, a particular relation between the casting extrusion rate, curing rate, and printing rate different from the relation used in the 3D solvent cast printing of the other two of the cilia;

FIG. 13 shows an abstracted view of an artificial cilia array active braille sensor according to one or more embodiments, and example operations thereof detecting small, raised features while attached to a human/robotic fingertip;

FIG. 14 shows an abstracted view of artificial eyelashes according to one or more embodiments in example operations thereof in detecting dust and debris;

FIG. 15 shows an abstracted view of cilia sensors in accordance with one or more embodiments in example operations of detecting, via forming a closed circuit at rest and a separation upon disturbance, a hinge-like motion;

FIG. 16 shows an abstracted view of artificial cilia sensors according to one or more embodiments, implemented as waterproof and arranged as responsive to changes in water currents;

FIG. 17 shows via electric current vs time graph, respectively different current-time responses resulting from low force, i.e., lighter touching and bending of an example artificial cilia array than from high force, i.e., heavier touching and bending of the example array;

FIG. 18 shows a first snapshot from a video capture of a subject's finger applying a light touch and a second snapshot from a video capture of the subject's finger applying a heavy touch to an arrangement of conductive artificial cilia according to one or more embodiments;

FIG. 19 shows a simulacrum of a human eye with cilia directly printed atop the eyelid as one example illustration of the concept;

FIG. 20 shows a snapshot image of a resting, unbent, undisturbed state of two rows of printed artificial cilia eyelashes in accordance with one or more embodiments, and a snapshot image of a disrupted and bent state of certain of the artificial cilia due to a dust particle, producing a conductive contact mechanosensing of the dust particle in accordance with one or more embodiments;

FIG. 21 shows a current-time graph of current flow through the FIG. 20 artificial cilia eyelashes as they undergo the bending from the dust particle, forming an electrical connection;

FIG. 22 shows a temporally spaced sequence of snapshots from a video capture of inter-surficial motion between two cilia arrays held 90 degrees from one another on a plant stem and leaf, showing a mechanosensing according to various embodiments in which, as the leaf and its attached array bends away from the stem, the electrical connection is broken and the cilia become un-embedded;

FIG. 23 shows a current-time graph of the mechanosensing current reflecting the FIG. 22 bending away from the stem and the corresponding breaking of the electrical connection; for a leaf connected, fully bent, and partially bent;

FIG. 24 shows three temporally spaced snapshot images taken from a video capture of a pair of artificial cilia, in a mechanosensing arrangement according to one or more embodiments, immersed in a water flow producing a bending of one of the cilia toward the other, at a constant speed;

FIG. 25 shows a current-time graph of the mechanosensing current through the pair of artificial cilia and, for certain time intervals, through the water gap separating the two, showing a mechanosensing capability according to one or more embodiments;

FIG. 26 shows three snapshot images of a particular water flow mechanosensing arrangement according to one or more embodiments, having a thin relatively flexible artificial cilium with a conductive distal cap adjacent a thick, relatively stiff artificial cilium, immersed in deionized (DI) water and the water stirred perpendicular to the cilia's orientation, the first of the three snapshots captured while the stirring was at a first stir rate, the second of the three snapshots captured while the stirring was at a second stir rate, higher than the first; and the third of the three snapshots captured while the stirring was at a third stir rate, which was the highest of the three;

FIG. 27 shows three current versus time plots, one for each of the three stir rates, each showing oscillatory current versus time;

FIG. 28 shows four snapshot images of the mechanosensing arrangement of FIG. 26, while in a variable air flow, the first of the four snapshots captured in still air, i.e., zero rate airflow; the second of the four snapshots captured while the airflow was at a first flow rate; the third of the four snapshots captured while the airflow was at a second flow rate, higher than the second flow rate; and the fourth of the four snapshots captured while the airflow was at a third flow rate, higher than the second flow rate;

FIG. 29 shows a current versus time plot segmented into three successive time intervals, the air flow being at the first flow rate for the first time interval, at the second flow rate for the second time intervals, and at the third flow rate for the third time interval;

FIG. 30 shows a graph of viscosity vs time data obtained using rheology measurement during a curing process of four PCL composites was measured during the curing process;

FIG. 31 shows a two-dimensional plot of conductivity and Young's modulus vs graphene concentration data, showing the Young's modules and the conductivity to increase with increasing graphene concentration, in other words, showing the composites become more rigid and more conductive with increasing graphene concentration;

FIG. 32 shows a two-dimensional graph representation of contact angle of PCL with 0% graphene concentration, and four specific concentrations of graphene;

FIG. 33 shows four captured scanning electron microscope (SEM) images, each of the SEM images being for a different one among four different PCLG composites;

FIG. 34 shows a photographic image of two different arrays of artificial cilia, each fabricated in accordance with one or more method embodiments and each structured in accordance with one or more structural embodiments, showing the various arrays and arrangements of arrays of artificial cilia can according to various disclosed embodiments can provide reproducible response to bending, stretching, and torsion;

FIG. 35 shows a verification of no material piezoelectric effects, comprising a sequence of three snapshot images, arranged above a two-dimensional plot of current versus bending angle, the snapshot images showing an artificial cilium structured in accordance with one or more embodiments being selectively bent by a variable force while connected to a voltage supply; as can be seen in FIG. 35 current remained constant despite changes in bending angle.

FIG. 36 shows a 2D stress-strain curve of pure PCL at increasing concentrations of wt % for PCL1, PCL2, PCL3, PCL4;

FIG. 37 shows on a 2D stress versus strain graph four data plots, one for each of four different PCL/graphene composites having, respectively, a first, second, third, and fourth weight percentage values;

FIG. 38 shows on a 2D current versus voltage graph four data plots, one for each of the four different PCL/graphene composites having, respectively, a first, second, third, and fourth weight percentage values respectively, showing that conductivity has a marked increase with graphene concentration, and the current voltage relationship is linear (Ohmic) for voltages within a certain limit;

FIG. 39 shows an Euler-Bernoulli beam theory analysis for the bending of artificial cilia under a uniformly distributed force;

FIG. 40 shows a perceptive sensing application;

FIG. 41 shows, on a 2D graph of intensity versus Raman shift graph, a Raman spectroscopy of pure graphene, pure PCL, PCLG1, PCLG2, PCLG3, and PCLG4;

FIG. 42 shows, on a 2D graph of intensity versus energy, an X-ray photoelectron spectroscopy (XPS) plot of the composites PCLG1, PCLG2, PCLG3, and PCLG4 near the characteristic carbon peak; and

FIG. 43 shows, on a 2D force versus midpoint displacement graph, a plot pf applied forces as a function of bending distance for a single cilium of PCL.

### DETAILED DESCRIPTION

We introduce a novel sensing approach that utilizes an array of conductive cilia called inter-cilia contact. According to one or more embodiments, two conductive electrodes, e.g., 3D printed silver epoxy electrodes, can be connected to a current source to form a current source and drain. Cilia on either end of the device are electrically connected to the source and drain. When the cilia sensor is subjected to air, water flow, vibration, or any one or more among various other types of mechanical disturbance, the ends of one more of the cilia that connect to one of the conductive electrodes can contact the respective end or other surface of at least of the cilia that connect to the other of the conductive electrodes. The first of such cilium-to-contacts establishes a closed circuit, resulting in a current flow from the current source, to the first electrode, returning to the current source from the second electrode. Each additional cilium-to-cilium adds a parallel current path, increasing the current flow.

The specific size and number of cilia involved in the sensor are variable and can be changed for different scales and different applications. At minimum there is one source cilia and one drain cilia, but there may be many rows of cilia. The cilia between the source and drain cilia are allowed to be initially unconnected and electrically neutral, where a stimulus will induce contact with adjacent source and drain cilia and allow current flow. The number of cilia in contact and the contact area between adjacent cilia change the current allowed to pass through the device. The change in current through the device as a function of time gives detailed information about the strength and frequency of the stimulus causing the cilia to deflect. This device can be configured in multiple ways depending on the target stimulus. Two sets of cilia attached to a respective source and drain can be set up with different substrates and initially connected, and as one substrate bends, slides, or vibrates with respect to the other the change in contact facilitates a detectable current change. Alternatively, for flow sensing in water, a default configuration of cilia not in contact can still produce some current flow through the water electrolytes. In this case, the bending of a single cilium towards another cilium, even in the absence of contact, creates a change in the current through the device. This detection method provides both reception and perception capabilities, and its scalability and simplicity make it suitable for a variety of industrial, biosensing, and accessibility applications.

The framework of manipulating an array of cilia across a stationary surface ‘perceptive sensing’ and demonstrate its proof of concept in a braille sensor. As will be understood from reading this disclosure, capabilities of perceptive sensing mechanosensor include, but are not limited to, detecting small features and acting as a brush that can drag along a raised surface.

Another application is a cilia sensor that models human eyelashes. This sensor is able to detect if a force, such as that of falling debris, is placed onto the cilia/eyelashes and is referred to as ‘receptive sensing’. Such sensors may be useful in robotics, and even pursued as a treatment for those with alopecia. The third configuration consists of two arrays of cilia on perpendicular substrates embedded within one another, forming a closed circuit. When the two substrates move apart from one another, the conductive pathway is broken (open circuit). This type of sensing we refer to as ‘inter-surficial’ motion and may be modeled after how a leaf bends from rainfall or the landing of an insect. The fourth configuration is another receptive sensor type to measure water flow. Unlike sensors exposed to the air, the innate electrolytes in water create a closed circuit without the cilia touching. The flow of water brings the cilia closer together, reducing the length of the pathway between cilia and increasing current through the system. Lastly, a cilia array is designed to detect changes in airflow.

As used herein, adjectives “first,” “second,” “third,” etc., except where description clearly indicates otherwise, are used for separate referencing of, for example and without limitation, individual structures, actions, instants of time, and operations, and are not intended and are not to be understood as specifying, indicating, defining, stating, implying, or reflecting any ordering or sequencing, temporal or spatial, or in terms of any qualitative or quantitative metric.

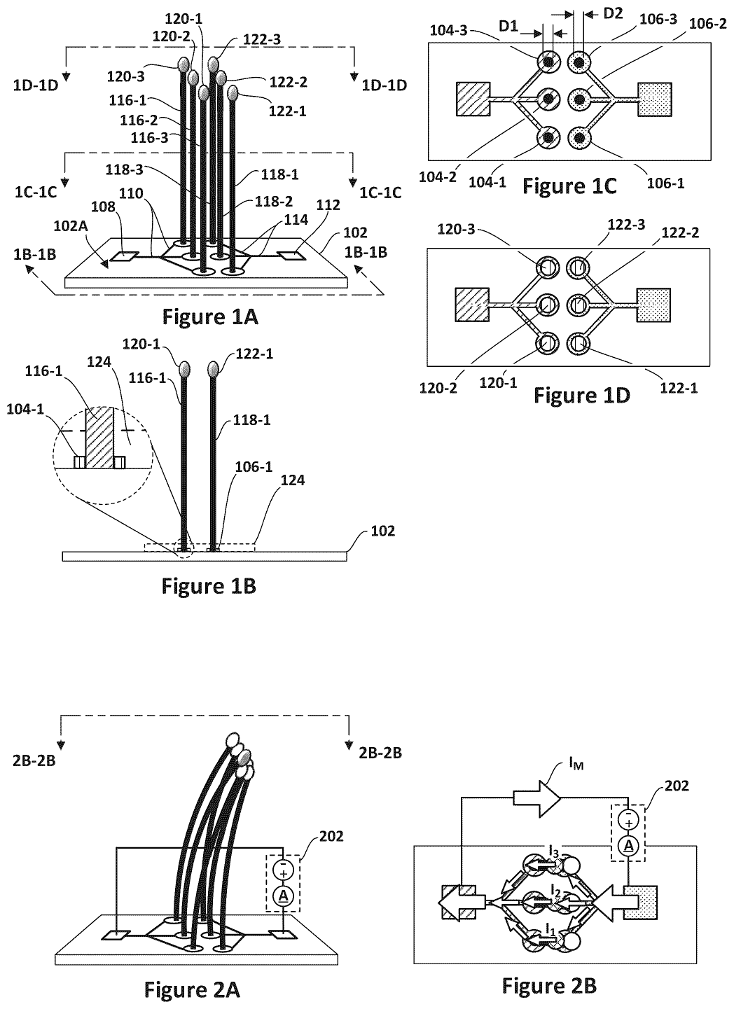

FIG. 1A shows a 3D schematic diagram of one example structural arrangement 100 for various dual array 3D-printed artificial cilia conductance based mechanosensors according to various embodiments. The structural arrangement 100 comprises a substrate 102 providing a support surface 102A and, deposited on the support surface 102A by 3D printing operations further described in subsequent paragraphs, an example combination and arrangement of conducting elements that include a first cilia type first coupling support 104-1, a first cilia type second coupling support 104-2, and a first cilia type third coupling support 104-3, also referenced collectively as “first cilia type coupling supports 104.” The structural arrangement 100 also includes an arrangement of second cilia type coupling supports, cooperative in terms of spacings and directions of spacings with the arrangement of first cilia type coupling supports and comprising a second cilia type first coupling support 106-1, a second cilia type second coupling support 106-2, and a second cilia type third coupling support 106-3, referenced collectively as “second cilia type coupling supports 106.”

The example combination and arrangement of conducting elements on the support surface 102A can include a first terminal 108 and a first connecting trace 110 electrically connecting the first terminal 108 to each of the first cilia type coupling supports 104, and a second terminal 112 and a second connecting trace 114 that electrically connects the second terminal 112 to each of the second cilia type coupling supports 106.

Vertically 3D printed on the support surface 102A with respective alignments with and conductive couplings to the first cilia type coupling supports 104 are a first type first cilium 116-1, a first type second cilium 116-2, and a first type third cilium 116-3, referenced collectively as “first type cilia 116.” In a similar manner, with respective alignments with and conductive couplings to the second cilia type coupling supports 106 are a second type first cilium 118-1, a second type second cilium 118-2, and a second type third cilium 118-3, referenced collectively as “second type cilia 118.” The first type cilia 116 are formed, as described in more detail in later paragraphs, with structural and material content parameters providing the first type cilia a desired first type bendability and first type elasticity. The second type cilia 118 can be formed with associated structural and material content parameters providing a desired second type bendability and second type elasticity.

According to various embodiments, the first type bendability and first type elasticity can be set such that the first type cilia exhibit greater bending than the second type cilia. Also, in accordance with various embodiments, different cilia among the first type cilia 116 can be fabricated with respectively different bendability and elasticity. Also, different cilia among the second type cilia 118 can be fabricated with respectively different bendability and elasticity.

Visible in FIG. 1A is a first cilia type first conductive cap 120-1, a first cilia type second conductive cap 120-2, and a first cilia type third conductive cap 120-3 (collectively “first cilia type conductive caps 120”). Each of the first cilia type conductive caps 120 is conductively secured to the distal end of its corresponding first type cilia 116, e.g., the first cilia type first conductive cap 120-1 to the distal end of the first cilia first cilium 116-1, and so forth. The phrase “conductively secured to X,” as used herein, means securely attached to X, concurrent with being electrically connected to X. Example implementations of “conductively secured” include, without limitation, 3D printing of the conductive caps onto the distal ends of the artificial cilia using a two-part silver microparticle ink, conductive epoxy, such as the AA-DUCT 916 available from Atom Adhesives, 1 Acorn Street, Providence, Rhode Island, 02903-1028.

FIG. 1B shows a front view 1B of the example structural arrangement 100, from FIG. 1A projection 1B-1B. and FIG. 1C shows an intermediate top view from FIG. 1A projection 1C-1C, and FIG. 1D shows top view from FIG. 1A projection ID-1D.

It will be understood that the FIG. 1A-1D population of three first type cilia 116 and three second type cilia 118 is only one example and is not any limitation on practices according to disclosed amendments.

Referring to FIG. 1C, diameter D1 is a representative diameter for first type cilia 116 and diameter D2 is a representative diameter for second type cilia 118. It will be understood that in some embodiments D1 can be consistent, within acceptable fabrication tolerances, among the first type cilia 116 and D2 can be consistent, within acceptable fabrication tolerances, among the second type cilia 118. In some embodiments, some of the first type cilia 116 may be fabricated with different diameters D1 than others and, likewise, some of the second type cilia 118 may be fabricated with different diameters D2 than others.

Referring to FIG. 1D it is seen that in the resting state, the first cilia type first conductive cap 120-1 is spaced from all the second cilia type conductive caps 122. In like manner the first cilia type second conductive cap 120-2 and the first cilia type third conductive cap 120-3 are each spaced from all the second cilia type conductive caps 122. Accordingly, in the resting state, the dual array 3D-printed artificial cilia conductance based mechanosensor according to the structural arrangement 100 provides no conductance path from the first terminal 108 to the second terminal 112.

FIG. 2A shows from the FIG. 1A projection one example artificial cilia deflection state and its corresponding cilium-to-cilium conductance state, and a conductance detector 202 modeled as a current source-ammeter. The FIG. 2A cilium-to-cilium conductance state comprises the first cilia type first conductive cap 120-1 in conductive surface contact with the second cilia type first conductive cap 122-1, concurrent with the first cilia type second conductive cap 120-2 in conductive surface contact with the second cilia type second conductive cap 122-2, and also concurrent with the first cilia type third conductive cap 120-3 in conductive surface contact with the second cilia type third conductive cap 122-3.

FIG. 2B shows a current flow IM produced by the conductance detector 202 through the cilium-to-cilium conductance state established by the FIG. 2A deflection state. The current flow IM splits into three parallel branch flows, labeled I₁, I₂, and I₃. The three may be identical or approximately identical or, in some embodiments, may differ. For example, according to one or more embodiments one or more of the cilia or one or more of the conductive caps may be fabricated with cilium-specific or conductive cap specific conductance.

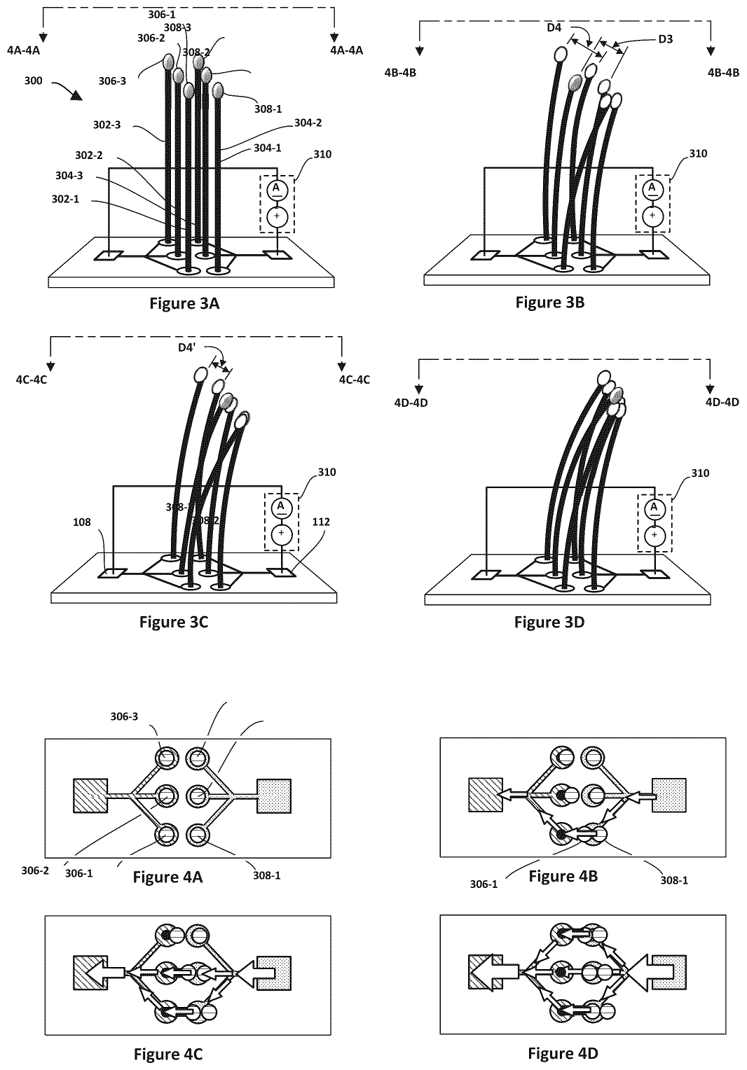

In the FIG. 2A example artificial cilia deflection state, the first cilia type first conductive cap 120-1 is in conductive surface contact with the second cilia type first conductive cap 122-1, concurrent with the first cilia type second conductive cap 120-2 in conductive surface contact with the second cilia type second conductive cap 122-2, and also concurrent with the first cilia type third conductive cap 120-3 being in conductive surface contact with the second cilia type third conductive cap 122-3. It will be understood that dependent at least in part on the first cilia types 116 having a common or a cilium-specific bendability characteristic and further dependent at least in part on the arrangement including a common or a varying spacing distance and spacing direction from each first cilia type coupling support 104 to its nearest second cilia type coupling support 106, there can be intermediate displacement states wherein one or more, but not all of the first cilia type conductive caps 120 are in conductive contact with at least one of the second cilia type conductive caps 122. One example arrangement in accordance with one or more embodiments is described in more detail in subsequent paragraphs, in reference, for example, to FIGS. 3A-D and FIGS. 4A-4D.

FIG. 3A shows a 3D schematic diagram of one structural arrangement 300 for a stepped conductance mechanosensing sensing dual array 3D-printed artificial cilia mechanosensor according to one or more embodiments. The structural arrangement 300 will be described, for purposes of focusing on concepts and features particular to stepped conductance concepts and implementations, using the already-described substrate 102, first cilia type coupling supports 104, second cilia type coupling supports 106, first terminal 108, first connecting trace 110, second terminal 112, and second connecting trace 114.

The structural arrangement 300 can include an arrangement of cilium-specific first cilia type cilia, respectively aligned and conductively secured to the first cilia type coupling supports 104, and a corresponding arrangement of cilium-specific second cilia type cilia, respectively aligned and conductively secured to the second cilia type coupling supports 106.

It will be understood that “cilium-specific,” as used in this description in the context of “cilium-specific first cilia type cilia” and “cilium-specific second cilia type cilia” means that different ones of the cilium-specific first type cilia and different ones of the cilium-specific second cilia type cilia can be configured, e.g., by respective differences in their fabrication steps such that the cilia's respectively bendings in response to subject force or subject disrupting event, over a given range of magnitudes or other parameter values, can produce a corresponding progression of cilia-to-cilia contact conductance states. This concept can be further understood and appreciated from this example.

Referring to FIG. 3A, the cilium-specific first cilia include, in the example arrangement 300, a cilium-specific first cilia type first cilium 302-1 conductively secured to the first cilia type first coupling support 104-1, a cilium-specific first cilia type second cilium 302-2 conductively secured to the first cilia type second coupling support 104-2, and a 3D printed cilium-specific first cilia type third cilium 302-3 conductively secured to the first cilia type third coupling support 104-3. Each of the cilium-specific first cilia is also adhered to the support surface, by the solvent cast 3D printing as described above, e.g., in reference to FIGS. 1A-1D, and as will be further described in more detail later in this disclosure.

In the arrangement 300, each cilium among the cilium-specific first cilia type cilia has a first cilia type conductive cap conductively secured to its distal end, and each cilium among the cilium-specific second cilia type cilia has a second cilia type conductive cap conductively secured to its distal end. Specific implementation includes a first cilia type first conductive cap 306-2, a first cilia type second conductive cap 306-2, and a first cilia type third conductive cap 306-3 (collectively “first cilia type conductive caps 306”), each conductively secured, respectively, to the distal end of its corresponding cilium-specific first cilia type cilium. The example implementation also includes a second cilia type first conductive cap 308-1, a second cilia type second conductive cap 308-2, and a second cilia type third conductive cap 308-3 (collectively “cilium-specific second cilia type conductive caps 308”), each conductively secured, respectively, to the distal end of its corresponding cilium-specific second cilia type cilium.

Description of a mechanosensing operation of the arrangement 300 assumes, for purposes of example, that cilium-specific first cilia type cilia are configured, generally, with bendability characteristics resulting in significantly greater bending than the cilium-specific second cilia type cilia. Description also assumes the subject force being in the force direction FD indicated on FIG. 3B. Description of the mechanosensing operation will further assume that the first cilia type first cilium 302-1 is configured as the most bendable, the first cilia type second cilium 302-2 as the second-to-most bendable, and the first cilia type third cilium 302-3 as the least bendable among the three first cilia type cilia.

An example mechanosensing will assume, for purposes of description, a starting state of no force being received by any of the cilia in the arrangement 300. Accordingly, as seen in FIG. 4A, there is no physical contact of any first cilia type conductive cap 306 with any second cilia type conductive cap 308. A result is no current path from the second electrode 112 to the first electrode 108.

Description assumes following the zero force state to applying the external force FD, with a starting magnitude not sufficient to produce non-negligible deflection of any of the first cilia type cilia or second cilia type cilia, then increasing magnitude to first produces an initial bending of the first cilia type first cilium 302-1, in the FD direction, toward the second cilia type first cilium 304-1. Since the first cilia type first cilium 302-1 is assumed, for this example, as the most bendable of the cilia, there may no other bending at this force level. As the force continues to increase the second cilia type first cilium 304-1 can begin to bend in the same direction. However, since the first cilia type first cilium 302-1 is configured as significantly more bendable than the second cilia type first cilium 304-1, as the force magnitude is further increased the net effect moves the first cilia type first conductive cap 306-1 progressively closer to and, eventually, to contact the second cilia type first cilium 304-1. The contact is shown by the first deflection state, which is seen in FIG. 3B.

As described above, this example assumes the first cilia type second cilium 302-2 is less bendable, i.e., stiffer than the first cilia type first cilium 302-1, and the first cilia type third cilium 302-3 to be stiffer than the first cilia type second cilium 302-2. Accordingly, as visible in FIG. 3B, a distance D3 remains between the first cilia type second conductive cap 306-2 and the second cilia type second conductive cap 308-2, and a distance D4 between the first cilia type third conductive cap 306-3 and the second cilia type third conductive cap 308-3.

FIG. 4B shows from FIG. 3B projection 4B-4B the current path from the second electrode 112, through a branch of the second connecting trace 114, through the second cilia type first coupling support 106-1, through the second cilia type first cilium 304-1, the second cilia type first conductive cap 308-1, the first cilia type first conductive cap 306-1, through the first cilia type first cilium 302-1, the first cilia type first coupling support 104-1, a branch of the first connecting trace 110, and to the first electrode 108.

It will be assumed that the force is further increased, However, since the first cilia type second cilium 302-1 is configured significantly more bendable than the second cilia type second cilium 304-2 the net effect moves the first cilia type second conductive cap 306-2 progressively closer to and, eventually, to contact the second cilia type second cilium 304-2. The contact is shown by the FIG. 3C second deflection state. However, since first cilia type third cilium 302-3 is stiffer than the first cilia type second cilium 302-2 a distance D4′ remains between the first cilia type third conductive cap 306-3 and the second cilia type third conductive cap 308-3.

FIG. 4C shows from FIG. 3C projection 4C-4C the second deflection state current path. As can be seen the path passes from the second electrode 112 through two parallel branches, one including surface contact of the second cilia type first conductive cap 308-1 against the first cilia type first conductive cap 306-1, the other including surface contact of the second cilia type second conductive cap 308-2 against the first cilia type second conductive cap 306-2.

As the force is further increased, the first cilia type third cilium 302-3 bends more than the second cilia type third cilium 304-3, and the net effect moves the first cilia type third conductive cap 306-3 progressively closer to and, eventually, to contact the second cilia type third cilium 304-3, attaining the FIG. 3D third deflection state, producing a third deflection state conductance path shown in FIG. 4D, which is from FIG. 3C projection 4C-4C. As visible the third deflection state conductance path passes from the second electrode 112 through three parallel branches, the first including surface contact of the second cilia type first conductive cap 308-1 against the first cilia type first conductive cap 306-1, the second including surface contact of the second cilia type second conductive cap 308-2 against the first cilia type second conductive cap 306-2, and the third including surface contact of the second cilia type third conductive cap 308-3 against the first cilia type third conductive cap 306-3.

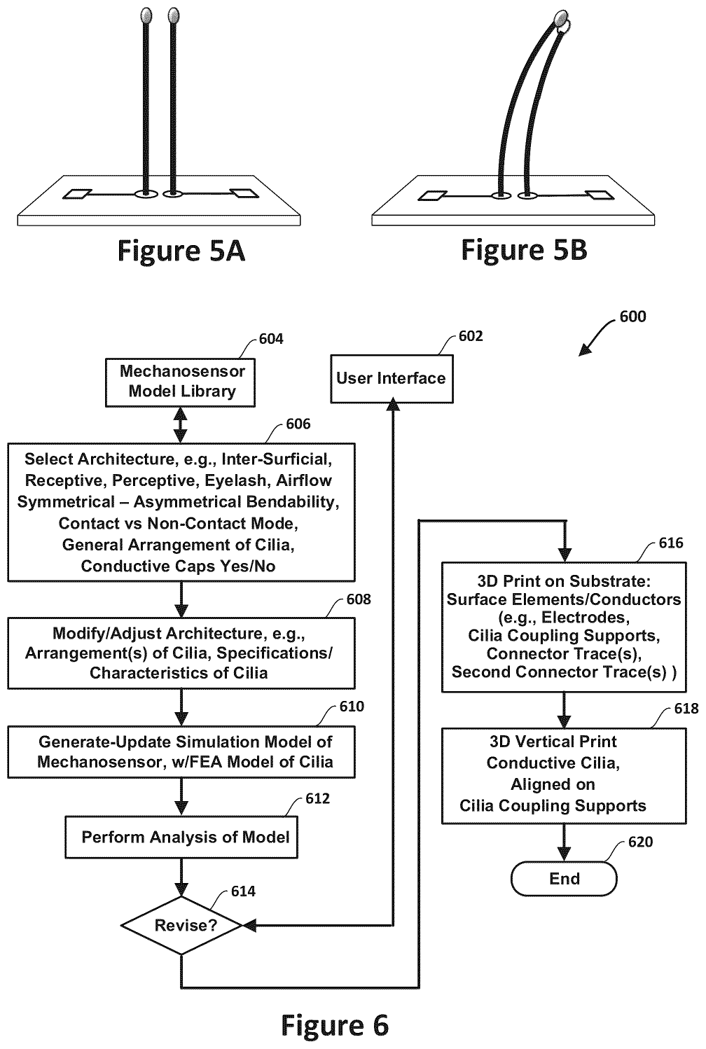

FIG. 5A shows a 3D schematic diagram of a resting state of one structural arrangement of a single-pair artificial cilia based mechanosensor according to one or more embodiments; and FIG. 5B shows an example deflected state, producing a mechanosensing ON state conductive path.

FIG. 6 shows a logic diagram of one operational flow, in accordance with one or more embodiments, in a process for fabricating conductance state based 3D printed artificial cilia sensors according to various of such sensor embodiments. FIG. 6 shows one flow diagram 600 for example operations in one process, in accordance with one or more embodiments, in a method for fabricating conductance state based 3D printed artificial cilia sensors according to various of such sensor embodiments. The flow diagram 600 is described in reference to fabricating the conductance state based 3D printed artificial cilia sensor structure, including a substrate supporting artificial cilia supportive coupling pads, conductive terminals, networks of interconnecting traces on the substrate, particularly structured and cooperatively arranged conductive artificial cilia, each aligned with and having its base end coupled to a respective supportive coupling pad, and secured to the substrate surface. According to one or more embodiments, structure can also include conductive caps on the distal ends of the artificial cilia, and can include certain protective, cilia-supportive layering on the substrate.

An instance of operations according to the process 600 can begin with user interface 602, which can comprise a graphical user interface (GRU) for operations of accessing, using for example one or more computer aided design (CAD) tools, a cilial array based mechanosensor library 604 and selecting, for example, mechanosensor architecture, e.g., inter-surficial, receptive, perceptive, eyelash, airflow. The selecting of architecture can also include, for example, selecting between symmetrical and asymmetrical bendability, surface contact vs non-contact code, modifying the library model's general arrangement of cilia, indicating or editing a conductive caps setting. Operations can then proceed to operations of modification-adjustment 608, of the architecture, e.g., the specific arrangement of the cilia or specification of the cilia. Operations can proceed from the operations in modification-adjustment 608 to a generating and/r updating of simulation model of the mechanosensor.

With continuing reference to FIG. 6, operations can proceed from operations of generating-updating 610 of the computer model to operations of performing 612 simulation analysis of the model. Such operations can include, for example and without limitation, selecting environment simulation parameters. These operations can be performed, at least in part, using the user interface 602. Operations in the process 600 can proceed from the operations in the performing 612 the simulation analysis to operations in deciding 614 whether or to revise design. Such operation can be based, for example, performance data obtained from the simulation. If the answer the decision to revise is a “Yes<’ operations can return to operation in modifying adjusting 608 the mechanosensor design.

Response to “No” decision in the operations at 614, operations in the process 600 can proceed to operations in 3D printing 616 on substrate, surface elements and conductors, such as first and second electrodes, first and second cilia type coupling supports, and connector traces. In an instance of the process 600, upon completion of operations in the 3D printing of surface conductors and elements, operations can proceed to interim testing, or can proceed to operations in 3D vertical printing 618 of the conductive cilia, in alignment with the cilia coupling supports, as described hereinabove, and as described in greater detail in later paragraphs. Upon completion of the operations in 3D vertical printing 618 operation can proceed to a termination or end 620. Such operations can include, for example various testing and inspection operations.

As will be understood by PHOSITAs from reading this disclosure in its entirety, configuration and specification of peripheral and supporting hardware, e.g. conductivity measuring circuitry, power supply, signal interfacing components, sensor housing, and power supply components, will be application-specific. Selecting the configuration, and selection and/or design of component parts can be readily performed by PHOSITAs, without undue experimentation via the application of standard engineering methodology and know-how.

Before printing an array of cilia, a conductive pathway of silver epoxy is first printed on the desired surface, forming two square electrodes connected to an array of circular ‘cups’. The cilia are printed so as to fill the cup, creating a current pathway between the cilia and the silver electrodes while still allowing the polycaprolactone-to-dichloromethane (PCL: DCM) ratio composite to adhere strongly to the flexible substrate. Printing the cilia directly onto the silver epoxy in a cup which is too small or in no cup at all may not promote good adhesion and the cilium may not stay firmly rooted on the substrate.

To print high-resolution, free-standing, and high aspect-ratio cilia structures, a printable ink that is both conductive and rapidly cured may be preferred. A polycaprolactone (PCL)-graphene composite fills this niche well; graphene acts as a conductive nanofiller to form a well dispersed conductive network while PCL is an easily accessible polymer with favorable mechanical properties and high impact resistance.

As graphene can be difficult to disperse within polymer matrices, determining a co-solvent for graphene and PCL can be a general guideline or preference. One framework to determine nanofiller-polymer interactions can be that of Hansen solubility parameters. The Hansen solubility parameters of PCL are 17.0 (dispersive), 4.8 (polar), 8.3 (hydrogen bonding), while those of graphene are 18, 9.3, 7.7. Therefore, dichloromethane (DCM) was selected as an accessible solvent, with solubility parameters of 17, 7.3, 7.1 that are comparable to both graphene and PCL. This similarity in parameters may be explained by the large, polarizable chlorine atom in DCM, which provides the London dispersion forces capable of solubilizing graphene (2D hydrophobic carbon sheets) and PCL (long polymeric chains).

The conductive, homogenous paste can be synthesized and transferred into, for example, a pressurized syringe and extruded through an appropriate inner diameter tip. One example, non-limiting inner diameter, can be 100 μm.

The DCM solvent evaporates rapidly as the ink is extruded, and the ink can harden quickly in the process known as solvent cast 3D printing. Preferably, at least for some embodiments, the tip can be moved upward, for example, continuously while extruding. rapid curing mechanism creates straight high aspect-ratio cilia if the tip is continuously moved upwards while extruding. Changing the pressure the ink is extruded with or the speed the tip moves at can change the straightness of these micro-sized cilia.

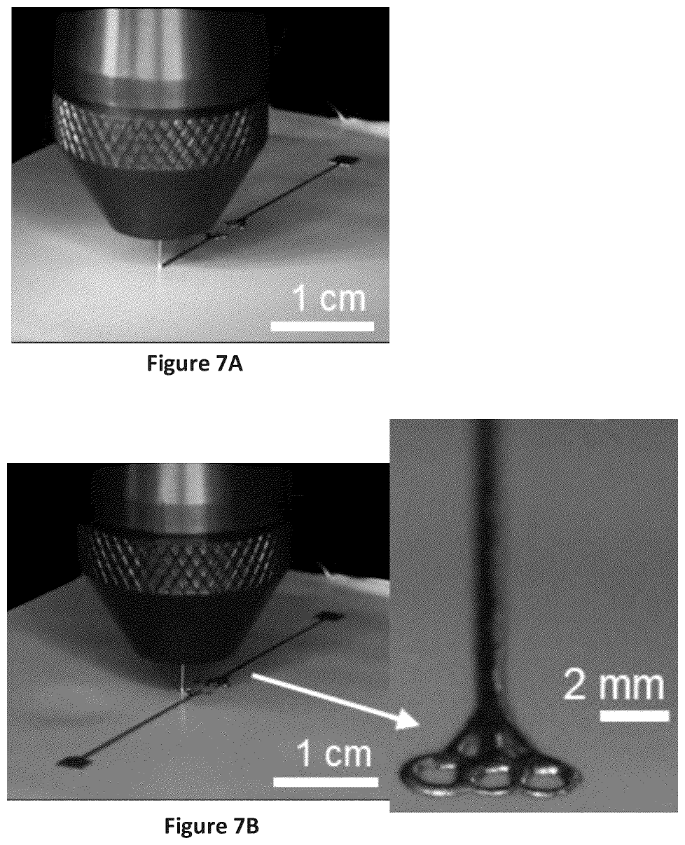

FIGS. 7A-7B show a snapshot image and a subsequent snapshot image, from one video capture of an example 3D silver epoxy printing, on a flexible substrate, of electrodes, cilia base coupling conductive cups, and connecting traces, in one example fabrication of one conductance state based 3D printed artificial cilia mechanosensor according to one or more embodiments.

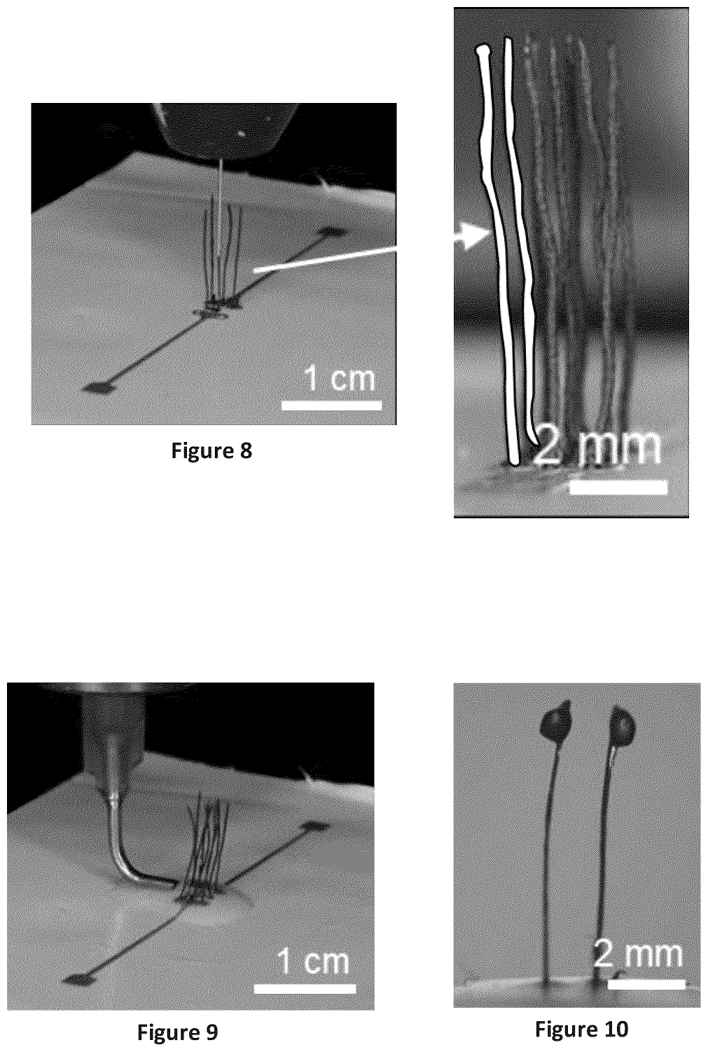

FIG. 8 shows a snapshot image from a video capture of an example 3D solvent cast printing of conductive artificial cilia printed at a high aspect ratio in the cups vertically with a larger bulbous base to promote good contact with the silver and adhesion with the substrate;

FIG. 9 shows a snapshot image from a video capture of a deposition of a dermal layer of Dragon-Skin to act like human skin, for holding the cilia firmly in place without disturbing the electrical pathway.

FIG. 10 shows a snapshot image from a video capture of an example adding of conductive distal caps to some cilia to promote greater contact area and statistical establishment of conductive contact.

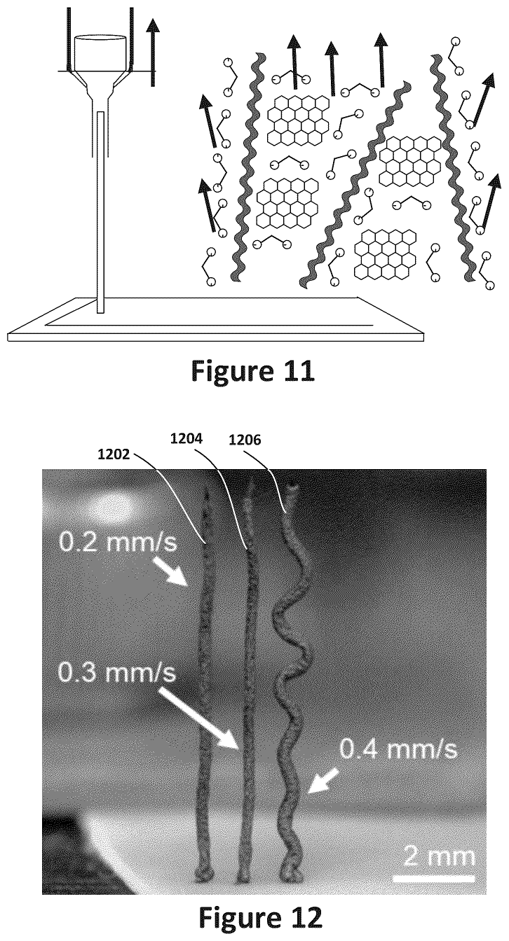

FIG. 11 shows an abstracted snapshot state in a 3D printing of conductive artificial cilia, annotated to show processing reactions, and illustrative of high aspect ratio printing in fabrication according to one or more embodiments.

FIG. 12 shows a photographic capture of external geometry of three different artificial cilia, 1202, 1204, and 1206, each of the three produced using, in its 3D solvent cast printing, a relation between the casting extrusion rate, curing rate, and printing rate different from the relation used in the 3D solvent cast printing of the other two cilia. As can be seen, vertical speeds of 0.3 mm/s (for artificial cilium 1204,) and 0.4 mm/s (for artificial cilium 1206) significantly change the straightness of the printed cilia. Tuning the extrusion rate, curing rate and printing rate such that the cilia are extruded at the same rate as the tip raises, and cure instantaneously allows for high aspect ratio devices.

Illustrative examples of artificial cilia, conductance based mechanosensors in accordance with various embodiments will be described. The illustrative examples are referred to according to the mechanosensing technique in which the mechanosensor can be used.

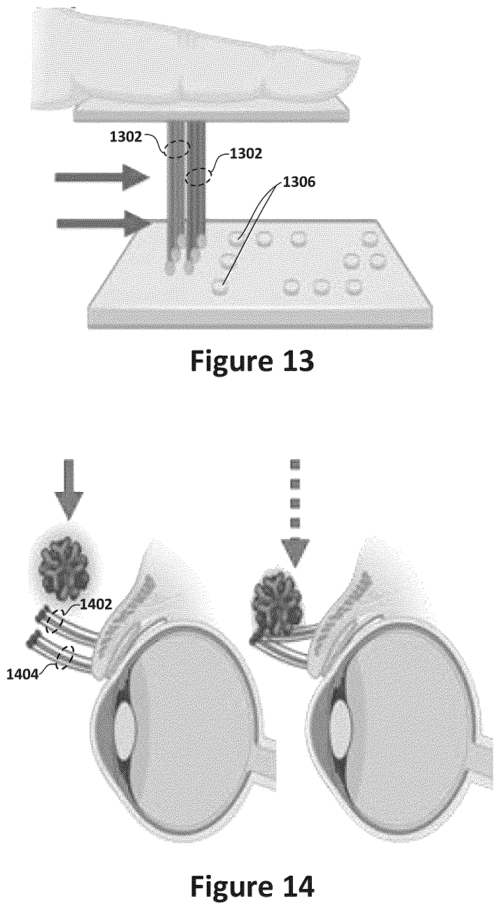

FIG. 13 shows an abstracted view of an active braille sensor in accordance with one or more embodiments detecting small, raised features while attached to a human/robotic fingertip. FIG. 13 shows an example of a framework of manipulating an array of cilia, comprising a first cilia type array 1302 and a second cilia type array 1304 across a stationary surface having small features such as the braille examples 1306. This framework of manipulating an array of cilia can be referred to as ‘perceptive sensing.’ A more detailed description of an example of this concept, e.g., in reference to FIG. 40, is set forth later in this disclosure.

Another conductance-based cilia mechanosensor concept that can be implemented according to various embodiments can be referenced, for purposes of description, as ‘receptive sensing.’ FIG. 14 shows, as an example, an abstracted view of artificial eyelashes in accordance with one or more embodiments, in a configuration that provides of detecting dust and debris. Implementations can, but are not limited to, a model of human eyelashes that provides detection of a force or disruption, such as that of falling debris onto the conductive cilia/eyelashes 1402,1404. Contemplated applications of receptive sensors may be useful in robotics, and even pursued as a treatment for those with alopecia.

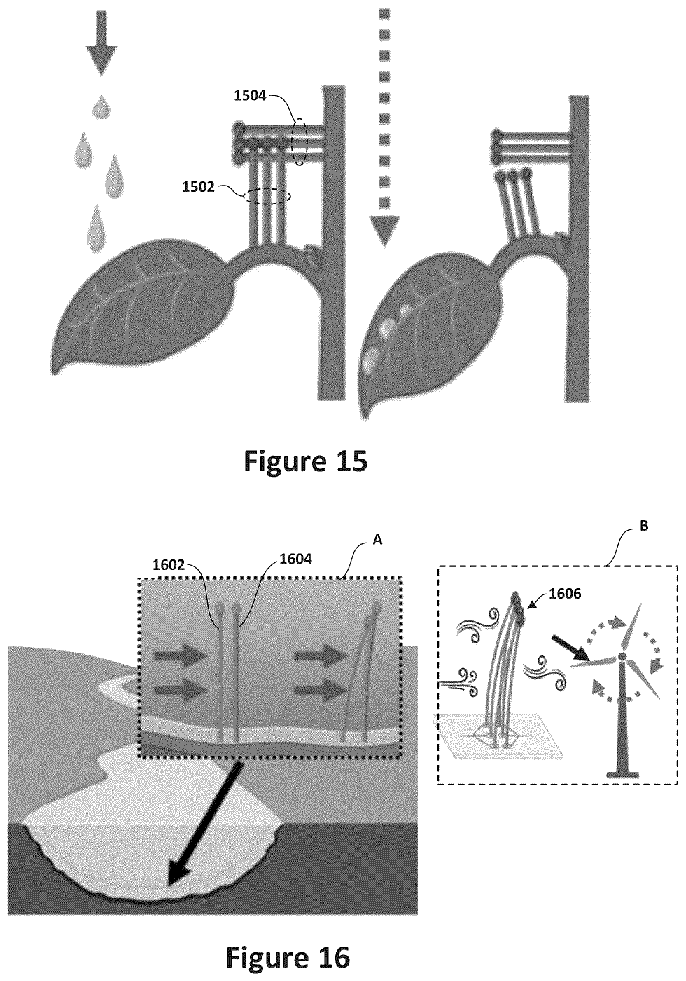

FIG. 15 shows cilia sensors in accordance with one or more embodiments detecting, via forming a closed circuit at rest and a separation upon disturbance illustrating a detecting hinge-like motion. Referring to FIG. 15, implementations of a third concept comprising two arrays of conductive cilia, e.g., a first array of cilia 1502 and a second array of cilia 1504 on respective substrates or other supports that, in the resting or default state “A” of the example, orient and place the first array cilia 1502 and the second array cilia 1504 in a mutually embedded arrangement, producing cilium-to-cilium contact which forms a closed circuit. When respective substrate or other supports move apart, e.g., when the leaf is deflected, the cilium-to-cilium contact is removed and conductive pathway is broken (open circuit). This type of sensing can be referred to as ‘inter-surficial’ motion and may be modeled after how a leaf bends from rainfall or the landing of an insect.

Visible in FIG. 16 are a fourth configuration, in figure region “A” and a fifth configuration in figure region “B.” A feature provided by the fourth configuration is a conductance-based measurement of flow in a fluid, such as water, having electrolytes. Unlike sensors exposed to the air, the innate electrolytes in water create a closed circuit without the cilia touching. The flow of water brings the cilia closer together, reducing the length of the pathway between cilia and increasing current through the system. Referring to the FIG. 16 fifth configuration, the cilia array is designed to detect changes in airflow. This design features cilia of different thicknesses, with the thinner cilium bending further than the thicker cilium in response to airflow perturbations. This asymmetry in bending sensitivity prevents the cilia from bending at similar distances and not coming into electrical contact.

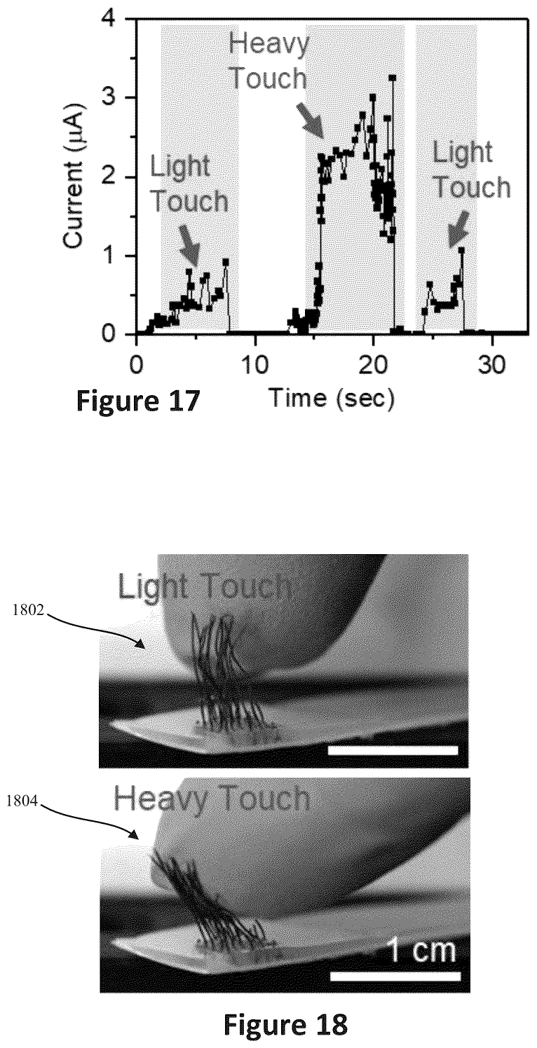

FIG. 17 shows, on an electric current vs time graph, two current-time responses; one showing inter-cilial contact based current flow produced during low force, i.e., lighter touching and bending of an example artificial cilia array, and the other showing inter-cilial contact based current flow produced during high force, heavier touching and bending of the example array.

FIG. 18 shows a first snapshot 1802 from a video capture of a subject applying a light touch and a second snapshot from a video capture of the subject applying a heavy touch to a visible arrangement of conductive artificial cilia 1806 according to one or more embodiments.

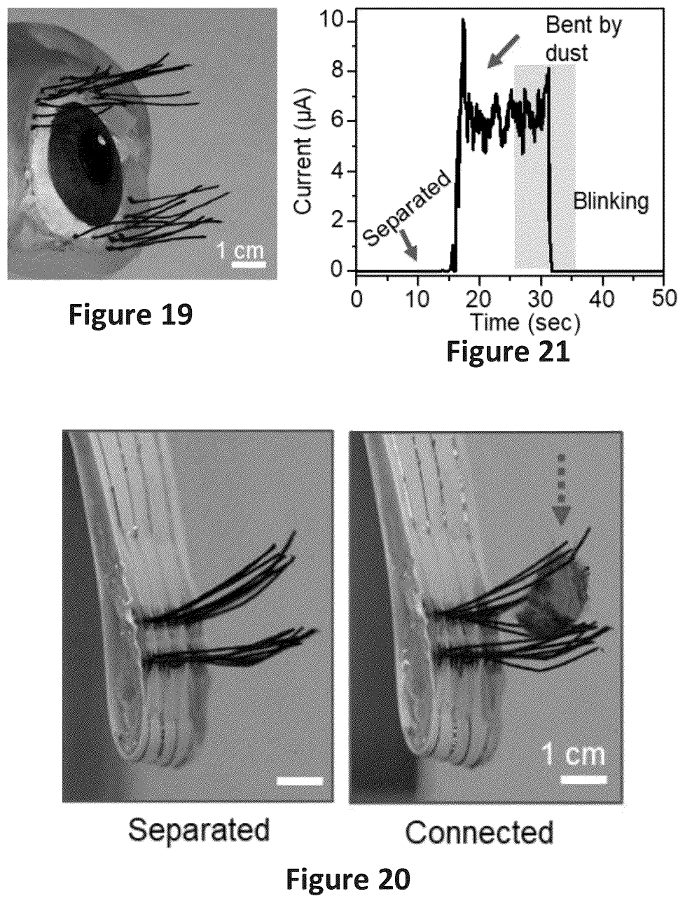

FIG. 19 shows a simulacrum of a human eye with cilia directly printed atop the eyelid, for illustration of concept.

FIG. 20 shows two rows of printed eyelashes on a single eyelid connected to electrodes and unbent;

FIG. 21 shows a current-time graph of current flow through the FIG. 20 eyelashes as they undergo bending from a piece of dust, forming an electrical connection.

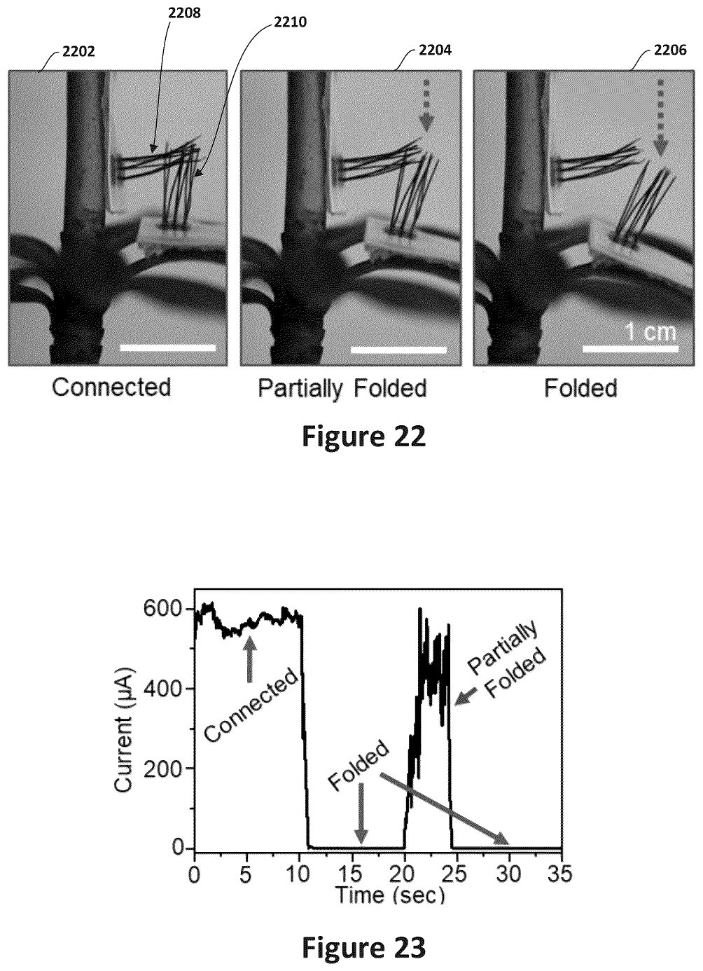

FIG. 22 shows three temporally spaced snapshots, 2202, 2204, 2206, from a video capture of inter-surficial motion between two cilia arrays, which are a first cilia array 2208 and a second cilia array 2210 held 90 degrees from one another on a plant stem and leaf. bending of the leaf and its attached second cilia array 2210 away from the stem can break the electrical connection, as the cilia become un-embedded.

FIG. 23 shows a current-time graph of the mechanosensing current reflecting the FIG. 22 bending away from the stem and the corresponding breaking of the electrical connection; for a leaf connected, fully bent, and partially bent.

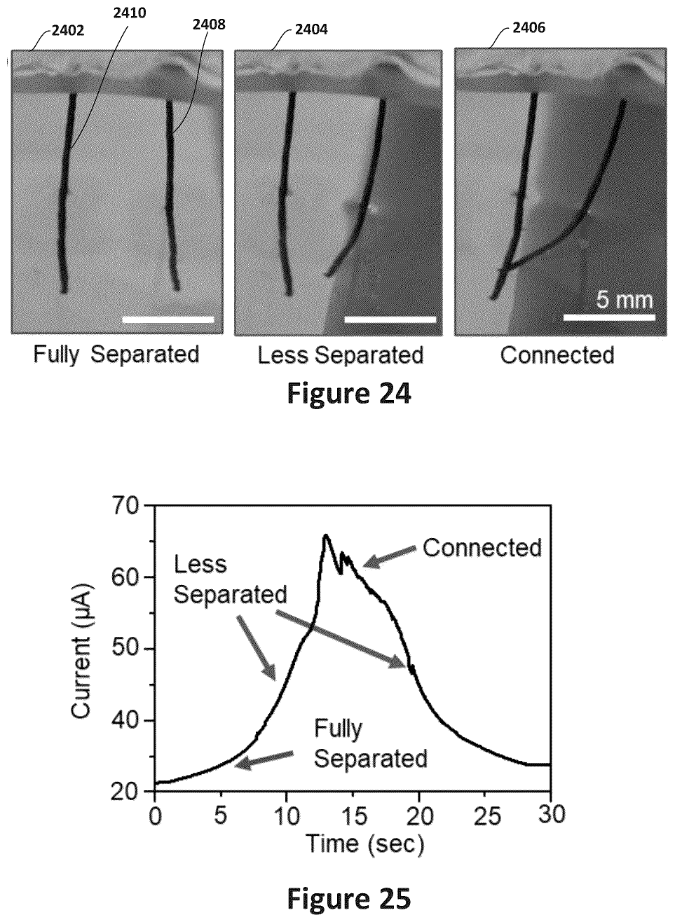

FIG. 24 show three temporally spaced snapshots, 2402, 2404, 2406, a first cilium 2408 bending at constant speed towards an unbent second cilium 2410 in DI water creating a steadily increasing peak because the autoionization of water lends a small amount of inherent conductivity. Snapshot 2402 shows the first cilium 2408 and second cilium 2410 fully separated; snapshot 2404 shows the two cilia less separated, and snapshot 2406 shows the first cilium bent to state of connecting with the second cilium.

FIG. 25 shows a plot of current amplitude versus time creates, which shows a steadily increasing peak because the autoionization of water lends it a small amount of inherent conductivity.

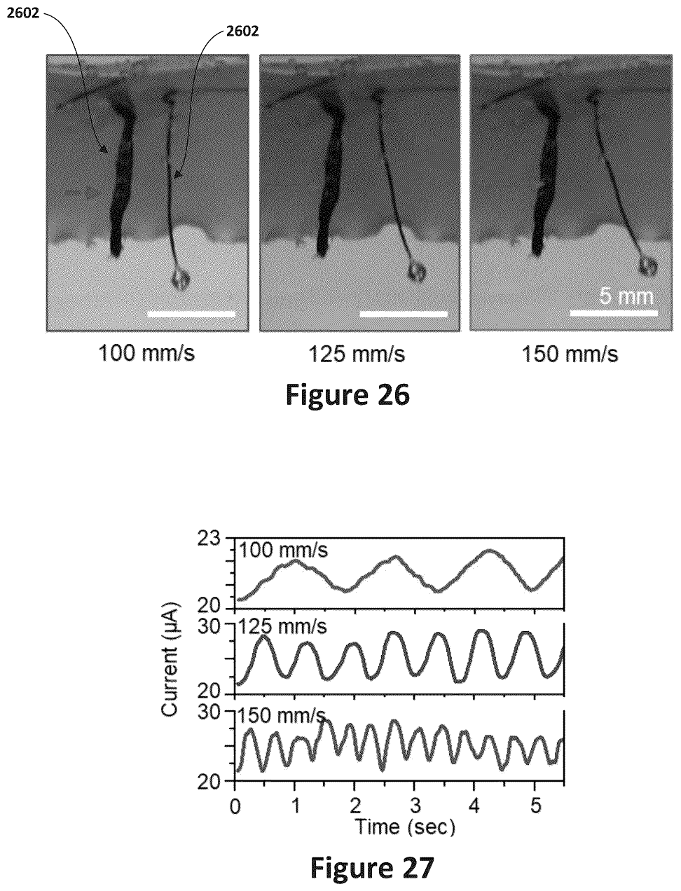

FIG. 26 shows three temporally spaced snapshots of a modified water flow sensor, formed with a thick cilium 2602 adjacent a thin cilium 2604 having a conductive cap, immersed in water and the water stirred at a first rate, then at a second rate, and then at a third rate;

FIG. 27 shows amplitude and frequency of current flow through the FIG. 26 thin cilium, through the oscillating length water gap separating the conductive cap of the thin cilium from the surface of the thick cilium;

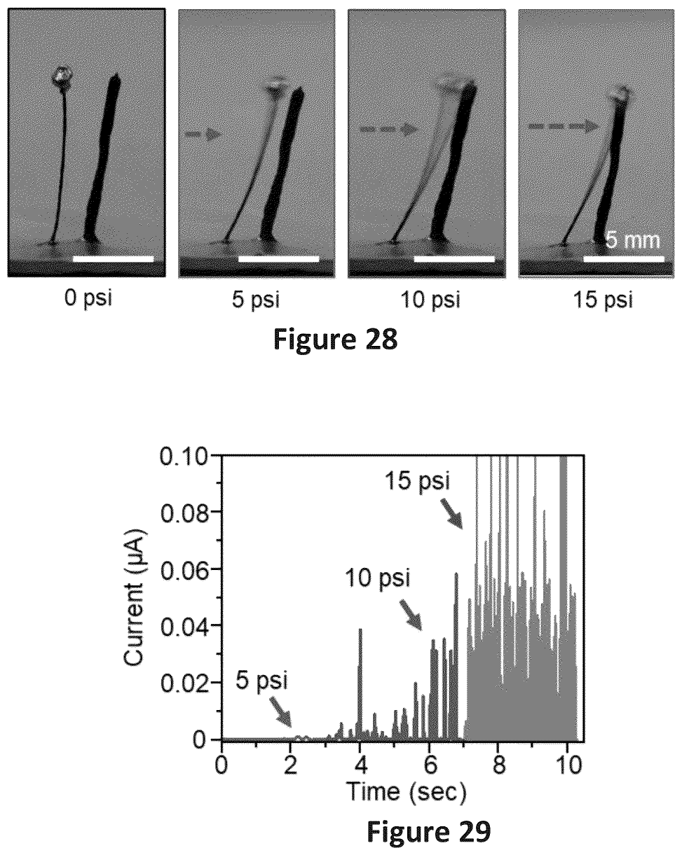

FIG. 28 shows four snapshots of orientation of a stiff cilium and thin cilium subjected to variable airflow, stepping from 0 psi to 5 psi to 10 psi, to 15 psi, in a direction urging the thin cilium toward the thick cilium. FIG. 29 shows a current versus time plot, indicating an oscillatory contact.

### System of Application-Adaptive Schematic Design

One or more embodiments can comprise a library of conductive artificial cilia types, a library of conductive artificial cilia arrangements, and a library of completed designs.

### 3D Printing Details

In an implementation, a fabrication process according to various embodiments can include a direct ink writing or solvent cast methods on a support surface of, for example, a substrate. The substrate may be, but is not necessarily flexible. The direct ink writing can form on the support surface, according to some implementations, a first cilium support pad, and positioned a spacing distance in a spacing direction from the first cilium support pad, a second cilium support pad. The first cilium support pad and second cilium support pad can be alternatively referenced as, for example, a first cilium coupling support and a second cilium coupling support, respectively. The direct ink writing steps forming the first cilium coupling support can be configured, in accordance with various embodiments, to form the first cilium coupling support with a geometry that includes a cup-shaped or ring-shaped base that can have an open floor opening, to provide an exposed surface of the substrate onto which the base of a first artificial cilium can adhere. The direct ink writing steps forming the second cilium coupling support can likewise be configured, in accordance with various embodiments, to form the second cilium coupling support with a geometry that includes a cup-shaped or ring-shaped base having an open floor opening providing another exposed surface of the substrate onto which the base of a second artificial cilium can adhere.

In one or more embodiments, the first cilium coupling support and the second cilium coupling support can each be configured to have an upward facing top opening. In this context, for this embodiment, “upward” can mean facing nominally away from, in a direction normal to the support surface.

The direct ink writing can be configured to form on the support surface, in accordance with various embodiments, a first electrode and a second electrode. The first electrode and the second electrode can be alternatively referenced, for example, as a first terminal and a second terminal, respectively. The direct ink writing can also form, on the support surface of the substrate, a first connector trace that can extend from a first connector trace first end coupled to the first electrode, to a first connector trace second end or distal end that can be coupled to the first cilium coupling support and, in some embodiments, to a plurality of first cilia coupling supports. The direct ink writing can also form, on the substrate support surface, a second connector trace that can extend from a second connector trace first end coupled to the second electrode, to a second connector trace second end or distal end that can be coupled to the second cilium coupling support and, in some embodiments, to a plurality of second cilia coupling supports.

According to various embodiments, after the 3D printed freestanding solvent casting of the micro-sized conductive cilia, a rubber ‘dermal’ layer can be printed on the substrate surface to encase the respective bases of the cilia. The dermal layer can further secure the artificial cilia to the substrate.

In an example, electrodes and cilia cups were 3D printed, and conductive caps were manually added with a two-part silver microparticle ink (Atom adhesives). The cilia were 3D printed with various combinations of the polymer polycaprolactone, graphene, and the solvent dichloromethane. Polycaprolactone (Sigma Aldrich) and graphene nanoparticles (Sigma Aldrich) were dissolved in DCM (Sigma Aldrich) for a day. Then the mixture was placed into a planetary centrifugal mixer (AR-100; Thinky) at 1400 rpm for 240 s, removed and stirred well, and then centrifuged for another 240 s. The dermal rubber layer was printed with Dragon Skin™ (Smooth-On). All devices were printed on a flexible tape substrate (Flex-Tape). The optimal ratio of PCL to DCM was found to be 30% PCL by weight (prior to adding graphene). Cilia sensors were printed with a custom robot gantry (A351, Physik Instrumente L.P.). The Gantry unit has precise control in X, Y, and Z dimensions, has multiple motors in Z to allow for multi-material printing, and operates in printing pressures from 0.1-300 psi using three independent pneumatic dispensing systems.

Referring to FIG. 17 larger arrays of 10×10 cilia may not require the caps as sliding past the next cilium in sequence still ensures contact with any of the other adjacent cilia.

Referring to FIGS. 26 and 27, 3D printing Ultimus V; Nordson EFD; OH, USA). The silver electrodes and cups were printed via planar direct ink writing with the Gantry unit. The silver cups were printed to simultaneously allow for the printed cilia to bind to their preferred target, the rubberized substrate, and to create contact between the cilia and the silver pathway to the electrodes. These cups, with their open floor, allow for the cilia to bind to the underlying substrate while maintaining electrical contact with the silver pathway. The cilia were vertically printed via 3D solvent cast printing where the ink is extruded and the solvent rapidly evaporates to harden the ink and adhere it to the substrate and create a free standing rigid microstructure in few seconds. For flow sensing applications, or for future applications it can be beneficial to have non-uniformly printed cilia, and 3D printing in accordance this disclosed embodiments can be well suited to such manufacture.

Changing the printing parameters or printing tip size allows for facile printing of differently sized cilia, in radius and length. The caps were added to devices with ten or fewer cilia to promote contact when the cilia would otherwise brush past one another. According to one or more embodiments, the conductive ‘caps’ on the tips or distal ends of the artificial cilia can be used on devices printed with, for example, 10 or less total cilia, e.g., two rows of three cilia or 1×2 array of thin cilia. The conductive caps can provide the sensing mechanism, particularly in such arrays with few total cilia, pronounced, continuous contact with one another. According to some embodiments, the conductive caps may be omitted from devices printed with a greater number of total cilia. Silver epoxy was manually added in a bulbous shape to the tops of these cilia to promote solid pronounced contact with increased contact area in cases where cilia may otherwise be deflected away from adjacent cilia. In larger arrays this may be unnecessary since deflecting away from the nearest cilia can still allow for contact with any of the many other nearby cilia. This sensor design can be utilized with any 3D printable conductive ink for the electrode, cup, and cilia layers, and any rubber for the dermal layer.

The components of the sensor can include, as shown in FIGS. 1A-1D, and FIGS. 3A-3D, and FIGS. 5A-5B, electrodes, cilia coupling supports or cups, cilia, dermal layer, and conductive caps. In some embodiments additional versatility can be provided by printing a thin layer of rubber at the base of the cilia. This can form a rubber ‘dermal’ layer, which can further bind the cilia in their intended place and can diffuse mechanical stress from stimulus on the tips of the cilia.

According to one or more embodiments, conductive caps comprising, for example, silver, may be added to the top of the cilia. The conductive caps can be beneficial for arrangements having a smaller number of cilia, for example a 2×3 processes according to one or more embodiments can be configured to form two non-identical cilia that can be used, for example, in a flow sensor to increase accuracy. An implementation can include one cilium, such as the example cilium 2702 in FIG. 27, being printed with a thicker, more stationary design and the other cilium, for example the example cilium 2704, being printed as thinner and more deformable. This allows for bidirectional sensing, with the thin cilium bending towards the thicker one in one direction and away from it in the other.

FIG. 26 shows a modified water flow sensor, formed with a thick cilium adjacent a thin cilium having a conductive cap, immersed in water and the water stirred at a first rate snapshot “A”, then at a second rate, snapshot “B” and then at a third rate, snapshot ‘C.” More specifically, a spherical probe was attached to the Gantry unit and used to stir the water in circular motions at varying stirring speeds. The current output between the cilia displayed harmonic behavior, with a clear positive correlation between the stirring rate and the frequency of the current data. At stirring rates of 0.8 Hz (˜100 mm/s), 1.6 Hz (˜125 mm/s), and 3.2 Hz (˜150 mm/s) under constant stirring radius and speed, the current output had frequencies of: 0.62 Hz, 1.37 Hz, and 2.50 Hz, respectively.

FIG. 27 shows amplitude and frequency of current flow through the FIG. 26 thin cilium, through the oscillating length water gap separating the conductive cap of the thin cilium from the surface of the thick cilium; Modified water flow sensor. Stiff and thin cilia were placed in DI water and stirred perpendicular to their orientation. Variable stirring rate induces variation in amplitudes and frequencies of current oscillation. The amplitude of the current oscillations also varies with the frequency of stirring, with a higher stirring rate producing larger flow speeds and displacement of the cilia further past their unbent positions, thus increasing the current amplitude.

### Characterizations of 3D Printing Inks

The ratio of PCL: DCM was iteratively studied in order to optimize the curing time, conductivity, and stiffness of the PCL/DCM/Graphene blend. Four blends were created at PCL weight percentages of approximately 10%, 20%, 30%, and 40%, and labeled PCL1, PCL2, PCL3, and PCL4, respectively. FIG. 31 shows the stress-strain curves of these increasing concentrations of PCL weight percentage. The stress-strain experiments were conducted on cylindrical samples of the ink, which revealed that the Young's moduli increased with increasing PCL concentration to ˜3.88, 7.02, 8.73, and 15.95 MPa respectively.

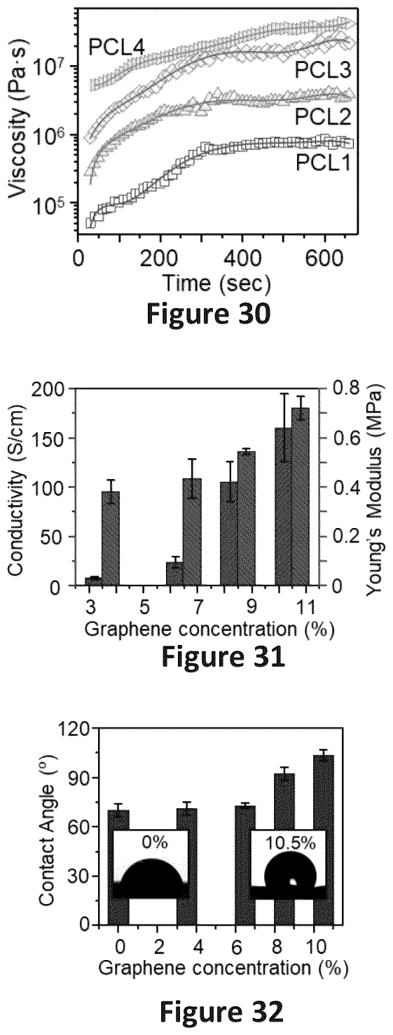

Rheological measurements were also performed to measure viscosity over a ten-minute period at a constant shear rate. FIG. 30 shows a viscosity vs time graph, of data obtained from rheological measurements during the curing process. Measurements were performed for four PCL composites. As seen in FIG. 30, the data revealed a nearly linear increase for over 300 seconds, followed by an asymptotic plateau when curing was complete. As seen in FIG. 30 the curing time and the corresponding viscosity increased with PCL concentration. The change in viscosity per unit time was smaller, and the time at which full curing was observed was longer with increasing PCL weight percentage.

Referring to FIG. 31, which shows a graph of conductivity and Young's modulus versus graphene concentration, these are seen to increase with increasing graphene concentration, showing the composites become more rigid and more conductive.

For printing purposes, the PCL: DCM blend with the optimal stiffness and curing time was selected to be PCL3. Graphene was then iteratively introduced into the ink at weight percentages of ˜3.5, 6.5, 8.5, and 10.5%, and labeled PCLG1, PCLG2, PCLG3, and PCLG4 at the fixed ratio of PCL3. As the graphene concentration in the blends increased, the conductivities and Young's moduli of the composites also rose, reaching ˜8, 24, 105, and 160 S/cm, respectively, and ˜0.38, 0.43, 0.54, and 0.72 MPa respectively.

FIG. 32 shows a two-dimensional graph representation of contact angle of PCL (0% graphene concentration), and four specific concentrations of graphene PCLG1 (3.5%), PCLG2 (6.5%), PCLG3 (8.5%), PCLG4 (10.5%). The wettability of the cilia in a sensor can be tuned with graphene concentration for applications in water or humid environments.

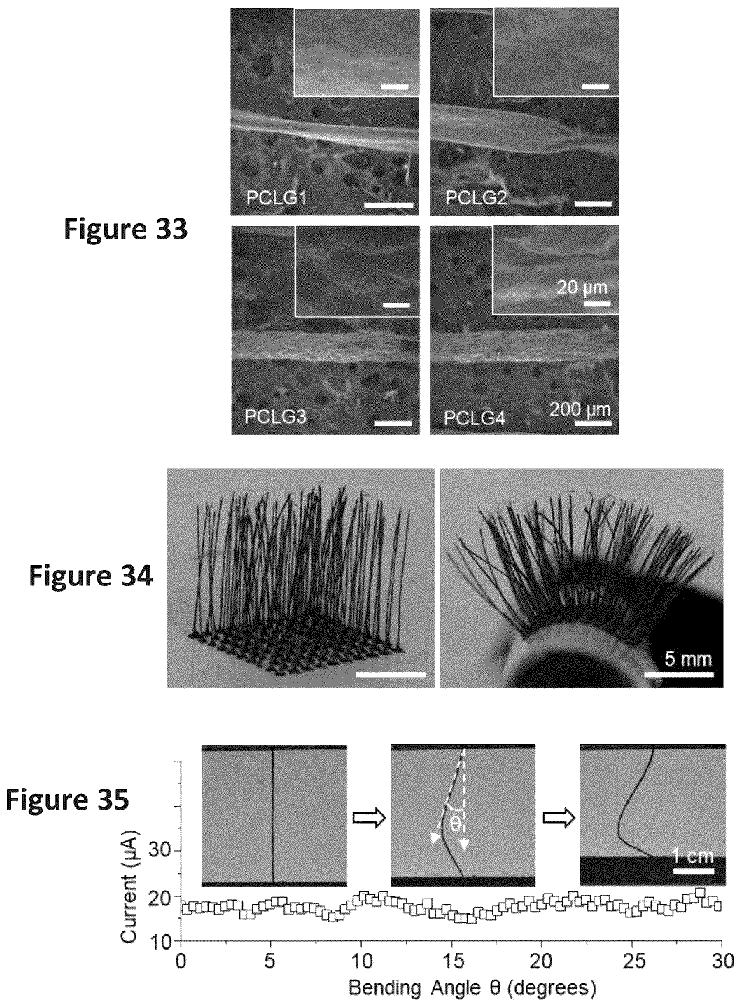

FIG. 33 shows scanning electron microscopy (SEM) was used to examine the cilia printed at different graphene concentrations FIG. 33. At lower concentrations, the higher weight fraction of DCM evaporating caused the cilium to twist and wrap around itself as it cured. Higher concentrations of PCL and Graphene resulted in a rougher, more cylindrical surface. As can be seen in FIG. 33, surface roughness increases markedly with increasing graphene concentration, and the general cylindrical shape is shown as retained best in concentrations with higher graphene volume fractions. It was found that a concentration of PCL: DCM: graphene (PCLG3) displayed good mechanical properties, high conductivity, and cured at the desired time frame without twisting.

FIG. 34 shows a photographic image of two different arrays of artificial cilia, each fabricated in accordance with one or more method embodiments and each structured in accordance with one or more structural embodiments, showing the various arrays and arrangements of arrays of artificial cilia can according to various disclosed embodiments can provide reproducible response to bending, stretching, and torsion. The cilia were printed on a one-sided adhesive ‘e-skin’ substrate, with the adhesive end allowing attachment to various surfaces and the rubberized backing being dissolved by DCM to improve adhesion.

At the onset of printing, the DCM in the ink dissolved the nonpolar rubber substrate, allowing the ink to bind to the substrate well. To further ensure the cilia were straight, the rate of evaporation, rate of extrusion, and rate that the tip was raised were balanced such that the material was extruded and hardened at the same rate that the tip moved up from the substrate. The specific resistances of the cilia were tested to determine if bending them had an effect on their performance FIG. 35. It was found that the cilia sensors were not significantly impacted by piezoresistive effects typical of strain sensors, suggesting that they are suitable for this inter-cilium contact based sensing application.

FIG. 35 shows a verification of no material piezoelectric effects, comprising a sequence of three snapshot images, arranged above a two-dimensional plot of current versus bending angle, the snapshot images showing an artificial cilium structured in accordance with one or more embodiments being selectively bent by a variable force while connected to a voltage supply; as can be seen in FIG. 35 current remained constant despite changes in bending angle. These results suggest that the cilia sensors are not prone to strain sensing or piezoresistive errors, making them suitable for sensing applications.

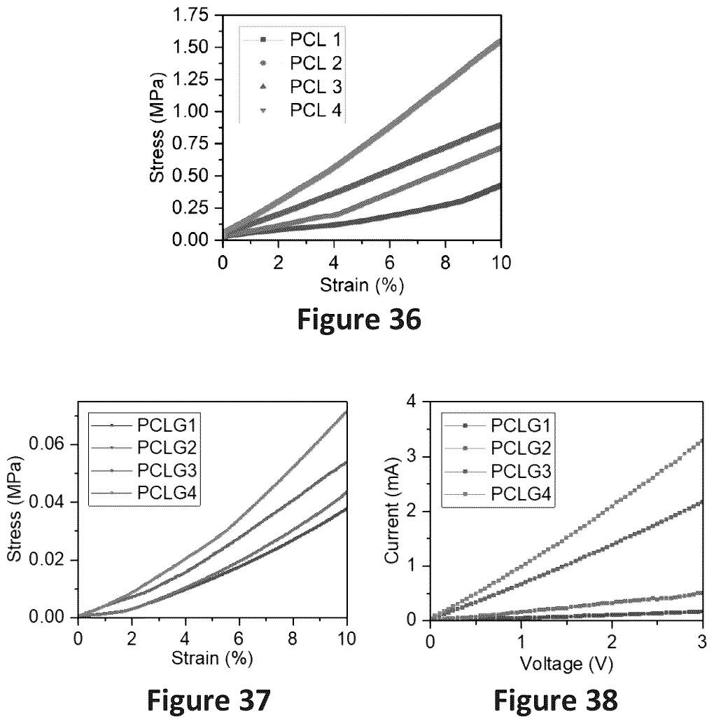

FIG. 36 shows a 2D stress-strain curve of pure PCL at increasing concentrations of wt % for PCL1, PCL2, PCL3, PCL4. The four curves correspond to Young's Moduli of 3.88, 7,02, 8.73, and 15.95 MPa respectively.

FIG. 37 shows on a 2D stress versus strain graph four data plots, one for each of four different PCL/graphene composites having, respectively, a first, second, third, and fourth weight percentage values.

FIG. 38 shows on a 2D current versus voltage graph four data plots, one for each of the four different PCL/graphene composites having, respectively, a first, second, third, and fourth weight percentage values with graphene wt % of ˜3.5, 6.5, 8.5, 10.5% respectively, showing that conductivity has a marked increase with graphene concentration, and the current voltage relationship is linear (Ohmic) for voltages within a certain limit.

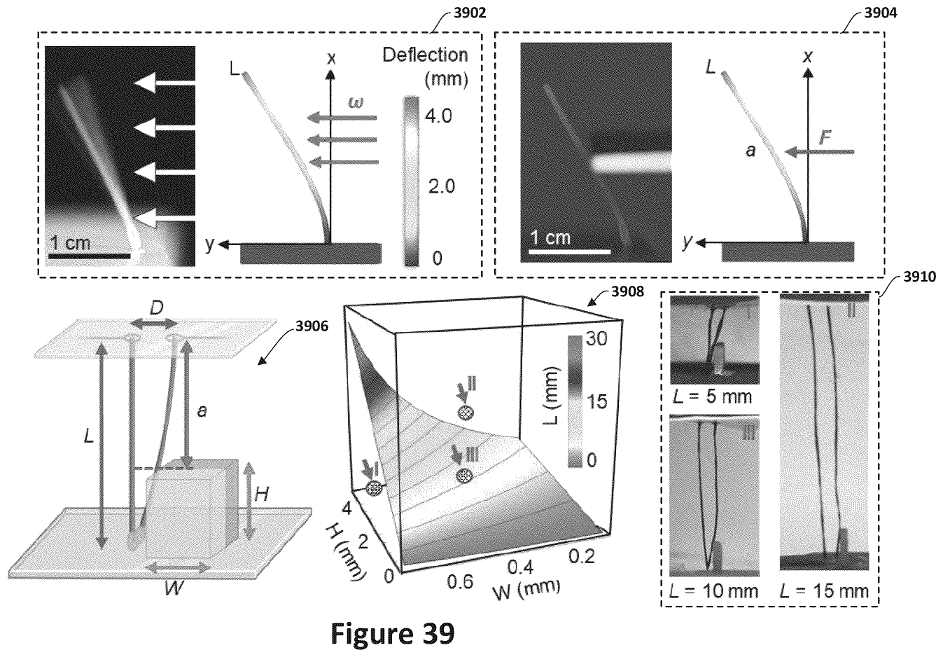

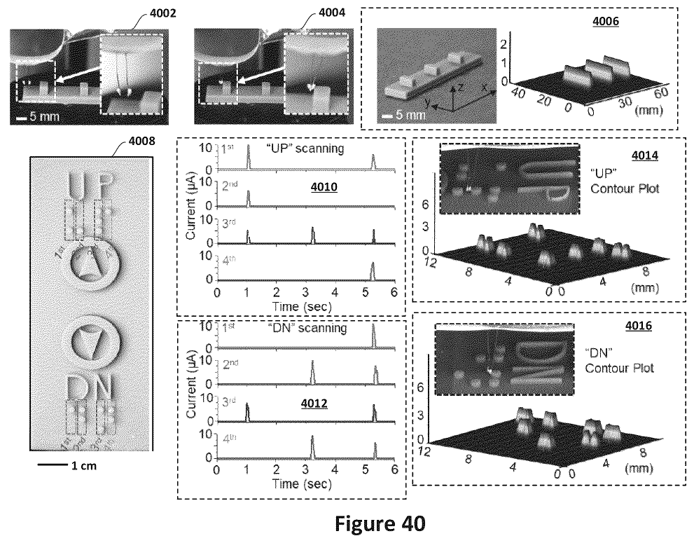

FIG. 39 shows an Euler-Bernoulli beam theory analysis for the bending of artificial cilia under a uniformly distributed force. Additionally, this theory can be used to explain the oscillation of a beam under the same linear pressure. By using the Euler-Bernoulli beam theory to model the response of cilia subject to point forces and linear pressures along the length of the cilium, design of the cilia can be customized to accurately detect stimuli of a predetermined size or strength. Additionally, the cilia sensor can be tuned in terms of thickness, length, and inter-cilia separation to optimize its response to a raised dot while ignoring features beneath a tunable threshold. The general expression for a cantilever beam of elastic modulus E, moment of inertia I, and length l, bending in response to a linear force density ω deflects an amount y at a point x along the beam:

$$y = \frac{{wx}^{2}}{24 El} ( {x}^{2} + 6 {l}^{2} - 4 lx ) \qquad Equation ( 1 )$$

The second category of bending type is in response to a point force F at a position “a” along the cantilever. For this point force, the bending of the cantilever is broken into two distinct regions:

$$y = \frac{{Fx}^{2}}{6 El} ( 3 a - x ) for 0 < x < a \qquad Equation ( 2 )$$

$$y = \frac{{Fa}^{2}}{6 El} ( 3 x - a ) for a < x < l \qquad Equation ( 3 )$$

Block 3902 of FIG. 39 shows a simulated analysis of a 100 μm-thick, 10 mm-long cilium bending under 1150 Pa pressure from airflow. Block 3904 shows experimental and simulated analysis of the same dimension cilium bending under 1.9 mN of force at 5 mm along its length. Block 3906 shows a schematic cilium of length/and separation q undergoing scanning at point a by a feature of width w and height h. Block 3908 shows a surface map of the cilia length necessary to induce contact while scanning a surface feature with variable width and height. Block 3910 shows three test cases in the 3D space, comprising a first test case, labelled “I,” a second test case, labelled “II,” and a third test case, labelled “III.” In the first test case the variables' values are: l=5 mm, w=0.45 mm, h=2.5 mm which rests below the surface and induces bending which is overly sufficient for contact. The third test variables' values are:/=15 mm, w=0.45 mm, h=2.25 mm which rests directly on the threshold surface and only just induces contact between cilia. The third test case variables' values are:/=10 mm, w=0.75 mm, h=3.5 mm which rests well above the surface and creates insufficient bending for contact.

To verify the models experimentally, a cilium made of PCL dissolved in DCM, without any nanofiller, was printed through a 100 μm diameter tip and stood 10 mm tall. The cilium was then subjected to a constant linear force of 115 mN/m from a controlled pressure dispenser set to 1150 Pa, generally according to FIG. 39, block 3902. This results in a maximum deflection of 4.30 mm at point I along the cilium. To further corroborate this model, FEA of a cylindrical beam of identical dimensions with an identical linear force along its length is performed, yielding a maximum displacement of ˜4.23 mm, in good agreement with the other model.

The sensitivity of the cilium to point force is measured by applying a force at point a=5 mm along its length, where the responsive force F is measured by a texture analyzer as it deflects, generally according to FIG. 39m block 3904. The maximum deflection of the end of the cilium is y=4.46 mm, the deflection of the midpoint which the probe manually deflects is y=3.00 mm with a measured responsive force of 7.5 mN, such as presented in FIG. 43. FEA of an identical cylindrical beam bound at one end with a point force at a=5 mm returned a maximum displacement of ˜4.93 mm, in good agreement with the experimental results and with an identical bending shape. The bending profile from the experiment and simulation also matches the theory, which predicts the bending is distinctly non-linear and cubic for x<a and linear for the region a<x<l.

Referring to FIG. 39, block 3906, a perceptive sensor can comprise two adjacent cilia which contact one another when one of the cilia is bent by a feature, such as a braille dot. Let the length of the two cilia be given as l, their unbent separation as q, and the surface feature's width and height as w and h, respectively. When the cilia contact the surface, a feature bends one towards the other at a point a (or l−h). The point force the cilium is subjected to then is located at point “a” along the cilium. The tip of the disturbed cilium may or may not contact the other cilium depending on the extent of bending and the width of the feature. The following two conditions use the point-bending equation presented above for a cilium deflected by a raised feature:

$${y}_{max} = d = \frac{{F ( l - h )}^{2}}{6 El} ( 3 l - ( l - h ) ) \qquad Equation ( 4 )$$

$${y}_{l - h} = w = \frac{{F ( l - h )}^{2}}{6 El} ( 3 ( l - h ) - ( l - h ) ) = \frac{2 {F ( l - h )}^{3}}{6 El} \qquad Equation ( 5 )$$

At point x=a, or x=(1−h), the cilium has deflected the full-width w. For some embodiments, for the two cilia to touch one another may necessitate the tip at x=1 having deflected the full d separation. And so, we rewrite d in terms of w and rearrange to obtain four equations for each parameter of the surface features and cilium properties:

$$2 ( l - h ) * d = w ( 3 l - ( l - h ) ) \qquad Equation ( 6 )$$

$$l = \frac{h ( 2 d + w )}{2 ( d - w )} \qquad Equation ( 7 )$$

FIG. 40 shows a perceptive sensing application, including, in figure region 4002, a 2×1 array of cilia did not bend, creating an open circuit. Figure region 4004 shows a 2×1 array contacting a surface feature closing the circuit, and creating a current pathway between cilia. Figure region 4006 shows a 3D surface map created from compositing multiple scans in the x direction at different positions in y and constant positions in z. Figure region 4008 shows an elevator button was modeled with CAD and printed with braille lettering for UP and DN. Figure regions 4010 and 4012 show a scan for the third column of the UP and DN braille with distinct current peaks for each braille dot at consistent points in time. Figure regions 4014 and 4016 show a contour plot of the composited UP and DN scans produce an accurate map of the braille cells.

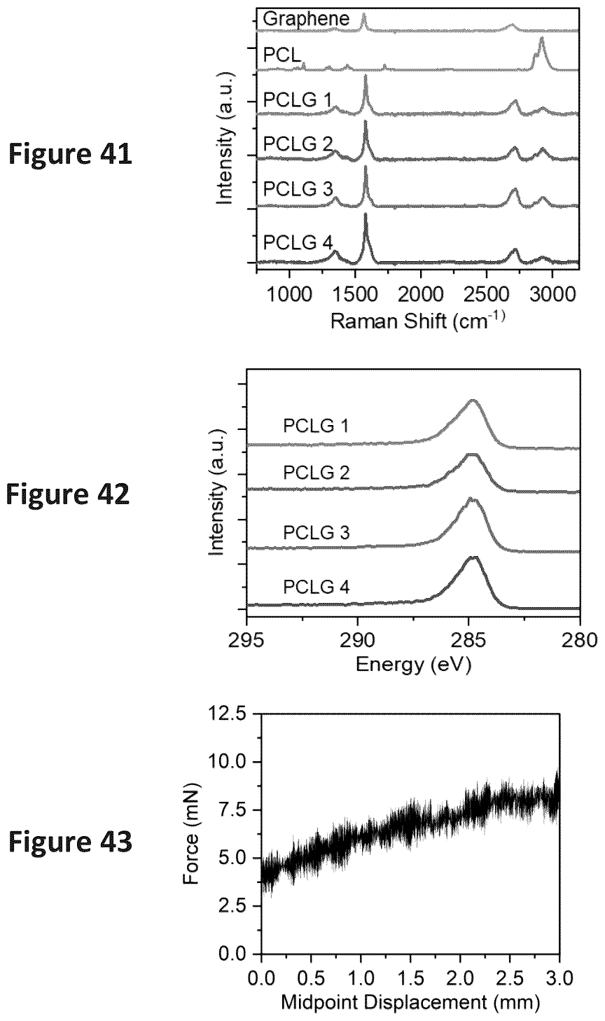

FIG. 41 shows, on a 2D graph of intensity versus Raman shift graph, a Raman spectroscopy of pure graphene, pure PCL, PCLG1, PCLG2, PCLG3, and PCLG4. The characteristic peaks for PCL and graphene are both present in each composite confirming their chemical character. The four composites are similar in shape and show no significant energetic shift with increasing graphene concentration.

FIG. 42 shows, on a 2D graph of intensity versus energy, an X-ray photoelectron spectroscopy (XPS) plot of the composites PCLG1, PCLG2, PCLG3, and PCLG4 near the characteristic carbon peak; shows there is no significant change in the energetic location of the C-C peak at 248.8 eV. These results were further confirmed through Raman spectra and Xray photospectroscopy (XPS), which showed that the composites were both stiffer and more conducive. The hydrophobicity of the PCL/DCM/Graphene composites was also tested via contact angle in order to determine their suitability for sensing applications in water and in humid environments. The contact angles of PCL without graphene, PCLG1, and PCLG2 are similar at roughly ˜70-72°, increasing to ˜92-100° indicating increased hydrophobicity with increasing graphene concentrations.

FIG. 43 shows, on a 2D force versus midpoint displacement graph, a plot pf applied forces as a function of bending distance for a single cilium of PCL. This experimentally provides the minimum force required to bend one cilium 1 mm to the nearest unbent cilium. This data is used to inform simulation in finite element analysis.

### Perceptive Sensing Surface Mapping for Braille Reading

A verification of concept was printed with a simple structure containing three prismatic surface features. To test the device, a 2×1 configuration was used as shown in FIG. 40 block 4002. If the adjacent cilia touched, the circuit would close, allowing electrical current to flow, as visible in FIG. 40 block 4004. Silver ‘caps’ were added to the tops of the cilia to ensure good contact interface. As described in other sections herein, a large sensor containing many adjacent cilia (e.g., ˜10×10 array) such as visible in FIG. 18, caps may not be necessary due to induced contact between non-adjacent cilia. A gantry controlled motion stage was used to scan the 2×1 sensor five times at a constant speed in the x-direction. Each trial was evenly spaced on the y-axis, with the z position of the cilia held constant.

Using the following simple MATLAB coding process, current data as a function of time was translated into a 3D plot of features at specific x and y coordinates, as visible in FIG. 40 field 4006.

### MATLAB Code

x=import_Data {: , 1}; % reads 1st column data
y=import_Data {: , 2}; % reads 2nd column data
z=import_Data {: , 3}; % reads 3rd column data
% get vector of data
xlin=linspace(min(x), max(x), 50);
ylin=linspace (min(y), max(y), 50);
% get grid coordinates from xlin and ylin
[X,Y]=meshgrid(xlin, ylin);
Z=griddata(x,y,z,X,Y, “nearest’); % can change ‘nearest’ to other values
mesh(X,Y,Z)

The program recognizes a data point corresponding to a raised feature if it meets either of the following criteria: the data point is in the range of >1 μA or has a first-time derivative of >1,000 A/s. Any significant spike or sustained current in the uA range or larger can be considered to be due to contact between the cilia. The 3D plot produced from the scan of these three features, as can be seen in FIG. 40 block 4006, was accurate and represented the physical geometry of the printed structure accurately.

A device equipped with a perceptive sensor constructed from dozens of adjacent cilia, attached to a fingertip, may prove highly useful in braille reading. The size of the braille characters was taken into account since they are standardized at a height of ˜0.9 mm, base diameter of ˜1.5 mm, and dot spacing of ˜2.5 mm.

An elevator button with braille lettering for the letters UP and DN was modeled as shown in FIG. 4 block 4008. The inter-cilia spacing was set to 1 mm and using related equations, the expected stimulus from the braille dots was tailored to a cilia length of ˜10.0 mm. To test the sensor, two sets of scans were conducted for the UP and DN braille characters, as shown in FIG. 40 blocks 4010 and 4012. The scans had consistent current readings and even spacing, given the constant scanning speed. The scans were then compiled and modeled in 3D space to produce two high-resolution 3D plots of the braille patterns, as shown in FIG. blocks 4014 and 4016. The contour plot suggests that the device can be suitable for modeling more complex surfaces with non-binary Z heights.

### Receptive Sensing: Bioinspired Eyelashes, Fow Rate and Inter-Surficial Sensor

One alternative to the perceptive sensor modality is the receptive sensor. Receptive sensors are not necessarily actively manipulated against or across a surface, and instead can respond to stimuli, including dust and debris, inter-surficial motion, water flow, and airflow. An example of a receptive sensing application is the use of artificial eyelashes, for example, as shown in FIG. 19 and FIG. 34.

Artificial eyelashes, comprising an array of, for example, 9×2 cilia, can be printed onto a flexible substrate to mimic a single eyelid with two rows of eyelashes, such as shown in FIG. 21 and/or in FIG. 34. When a piece of dust is placed onto the top row of artificial eyelashes, the cilia will bend downward and contact the bottom row of cilia, forming a current pathway as shown in FIG. 21. When the debris is removed, contact between the rows of cilia may be lost and the cilia return to their default orientation (blinking). Studies have proven that eyelashes have favorable aerodynamic interactions with air flow, and serve to divert air flow and particle deposition from the sensitive eye beneath. Therefore, such receptive sensors are useful in a variety of applications, such as drone-assisted camera networks with sensitive airborne camera lenses.

An alternate configuration of cilia is inter-surficial sensing, which involves the sensing of the motion between two surfaces. This is demonstrated in FIG. 15, which shows the movement of a plant leaf with respect to its stem. In comparison to perceptive sensing and the eyelash applications mentioned previously, this type of cilia has a closed circuit as its default state.

In the FIG. 15 example, two arrays of 3×3 cilia are oriented 90 degrees from each other and embedded within one another, allowing for the current to flow. When the leaf is bent away from the stem, either due to accumulated rainfall, an insect landing, or leaf growth, the cilia detach from one another and the current pathway is broken. This type of cilia sensing can be used to detect leaf wetness, plant growth, and plant health, and its versatility allows for multiple stimuli to be monitored simultaneously at tunable scales in environmental applications.

FIG. 22 shows a temporally spaced sequence of snapshots from a video capture of inter-surficial motion between two cilia arrays of an example artificial cilia conductance-based mechanosensor according to the FIG. 15 illustration. Snapshot 2202 shows the two cilia arrays held 90 degrees from one another on an unbent plant stem and leaf. Snapshot 2204 shows the leaf partially, to a degree such that the two arrays are partially folded, meaning that cilia maintain some contact. Snapshot 2206 shows the leaf fully bent, such that the two arrays are folded, breaking the electrical connection as the two cilia arrays become un-embedded.

FIG. 23 shows a current-time graph of the mechanosensing current during the FIG. 22 bending of the leaf away from the stem and corresponding breaking of the electrical connection; for a leaf connected, fully bent, and partially bent.

Receptive sensing can be used to detect flow in both air and liquid. In this case, a pressure can be applied to the entire surface. As a result, both cilia are affected, causing them to oscillate. In water, a closed circuit with non-zero current flow does not require contact between the cilia.

To observe the current flow between two cilia in deionized (DI) water, an experiment was conducted in which one cilium was manually deflected towards the other via a gantry unit. The results of this test showed, as can be seen in FIG. 25, that the scanning mechanism in water is functional, with a distinct peak present when the cilium was bent FIG. 25. Additionally, this data revealed the operating current range as the distance between the cilia decreases. At 1 mm apart, approximately 20 μA of current was observed to pass through the DI water, as see in FIG. 24. As the distance between the tip of the bent cilium to the unbent cilium decreased, the current increased to over 50 μA, before dropping back to 20 μA when they were separated again. This data provides insight into the response of cilia to water flow and can be used to accurately determine the separation between the cilia, resulting in high resolution information about water flow strengths and rates.

### EXAMPLES

### Ink Preparation:

The cilia were printed with various combinations of the polymer polycaprolactone, graphene, and the solvent dichloromethane. Polycaprolactone (Sigma Aldrich) and graphene nanoparticles (Sigma Aldrich) were dissolved in DCM (Sigma Aldrich) for a day. Then the mixture was placed into a planetary centrifugal mixer (AR-100; Thinky) at 1400 rpm for 240 s, removed and stirred well, and then centrifuged for another 240 s. The electrodes and cilia cups were printed with a two-part silver microparticle ink (Atom adhesives). The dermal rubber layer was printed with Dragon Skin™ (Smooth-On). All devices were printed on a flexible tape substrate (Flex-Tape).

The optimal ratio of PCL to DCM was found to be 30% PCL by weight (prior to adding graphene). This ratio was used for all cases of pure PCL. Four variations of the ink with increasing concentrations of graphene were synthesized and studied. The inks were denoted PCLG1, PCLG2, PCLG3, and PCLG4 corresponding to weight percentages of graphene ˜3.5, 6.5, 8.5, and 10.5%.

### Material Characterization:

A scanning electron microscope (SU-70 FE-SEM; Hitachi) at 10 kV was used to obtain micrographs. Tensile and compressive moduli were measured with a texture analyzer (TA. XT plusC; Stable Micro Systems). Young's moduli (S3 a-e) were calculated from the elastic region during compression. The compression and tension tests were performed with constant parameters, including a constant test speed with an iteratively increasing strain percentage. Tensile grips were used for all tension measurements. A cylindrical 1 cm2 stainless steel probe was used for compression measurements.

### 3D Printing Cilia Array Sensors

Cilia sensors were printed with a custom robot gantry (A351, Physik Instrumente L.P.). The Gantry unit has precise control in X, Y, and Z dimensions, has_multiple motors in Z to allow for multi-material printing, and operates in printing pressures_from 0.1-300 psi using three independent pneumatic dispensing systems (Ultimus V; Nordson_EFD; OH, USA). The silver electrodes were printed with a two part curable silver epoxy (Atom adhesives) with a 100 μm stainless steel tip with various shapes depending on the_application. The cilia were printed vertically in different configurations with various tip sizes including 100, 150, 200, and 300 μm, all stainless steel, depending on the application with our synthesized PCL/DCM/Graphene ink. After the cilia were printed, a dermal layer of Dragon-Skin™ (Smooth-On) was patterned with a 500 μm stainless steel tip at a thickness of roughly 500 μm to further secure the cilia in place. When necessary, some cilia were manually given bulbous silver caps (atom adhesives).

### Measurements:

Electrical conductivity measurements were performed with a source meter (2470 High Voltage SMU; Keithley). Conductivity was calculated from the linear region of a current-voltage sweep which was taken from-2V to 2V for each sample. Raman spectra were measured by a Raman Spectrometer (LabRAM HR Evolution; Horiba) with a 532 nm laser on dried composites of graphene and PCL with a DCM solvent. Contact angle measurements were taken with a goniometer (OCA 15, DataPhysics, USA). XPS spectra were obtained with a scanning XPS Microprobe (VersaProbe III; PHI) on a bead of pure PCL, graphene powder, and dried composites of graphene and PCL with a DCM solvent. Current vs time measurements were taken with a bias voltage of 2V with a sampling rate of 0.01s.

### Two-Cilia Example

An asymmetrical system is 3D printed, with one cilium thinner than the other. Since air has a high resistivity, the cilia should be close enough to induce current flow. To achieve this, the thinner cilium can be fitted with a ‘cap’ to ensure contact if the cilia become misaligned. Air pressures of ˜5 psi, 10 psi, and 15 psi were released from a dispenser ˜5 cm away from the 2×1 array, and the circuit's current was monitored. At 5 psi, the thin cilium was deflected but did not bend sufficiently to contact the thicker cilium. At 10 psi, the cap on the thinner cilium began to collide with the thicker cilium, producing an irregular but clear current signal near ˜0.2 μA. At 15 psi, the capped cilia consistently collided with the thicker cilia, increasing the current output near ˜0.06 μA. The irregularity in the current output can be due to small mechanical vibrations of the cilium, which arise from the interaction of the two cantilever beams in their own independent harmonic systems at high frequencies. The sensor's sensitivity to wind above a certain threshold is noteworthy. Air pressures lower than 5 psi did not generate enough mechanical force for the cilia to contact. This property can be tailored for applications in which it would not be efficient to detect background airflow. The sensor can also be adjusted for efficiency in a desired stimulus range, due to the 3D printing parameters that allow for cilia of specific sizes and thicknesses. This opens up opportunities for completely customizable airflow measurements.

### FEA Simulation:

FEA was performed to validate theoretical models of cantilever bending. A cilium of appropriate dimensions (100 μm diameter, 10 mm length) and with the material properties of PCL (Elastic modulus of 363.4 MPa, Ultimate tensile strength 10.5 MPa, Strain at break 0.043) was modeled in CAD software (Fusion 360) and subjected to a point force and a linear pressure. The displacement of the cantilevers is given by the thermometer and coloring.

We present a novel mechanosensing mechanism modeled on artificial conductive cilia. This mechanism uses a graphene-PCL nanocomposite ink, extrusion-based 3D-printing of the ink into high aspect-ratio cilia arrays, and the responsive electrical properties of these arrays to various stimuli.

Advantages of this mechanism include, but are not limited to, scalability, customizability, and versatility. These advantages apart from other mechanosensing cilia sensors based on magnetism or piezoelectricity.

The printing process, device schematic, sensing mechanism are novel. The printing method for a fully 3D printed cilia sensor with electrodes and pathways, and a rubber dermal layer printed via direct ink writing, and micro-sized cilia rapidly cured via vertical solvent cast 3D printing is novel and created for the specific specifications of the device schematic and sensing mechanism. The unique device schematic arises to accommodate the sensing mechanism, namely, to electrically connect micro-sized cilia to positive and negative electrodes, promote current flow upon their contact, hold the cilia in place upon printing, and to fix the cilia in place under strong stimulus so that they do not detach from the substrate.

The sensing mechanism can be straightforward which gives the device flexibility in its application. Any stimulus that would bend the cilia: wind, water flow, being used as a brush across bumps, being bent away from one another on a substrate, dust and debris, etc., can be capable of triggering an electrical response in the sensor.

The bendable, conductive cilia in this mechanism can exist in two states: contact and separation. As a result, the cilia sensor can detect any stimulus that differentiates between these two states, from changes in surface topology to airflow, water flow, the motion of two surfaces with respect to one another, and beyond. This multifunctionality is both cost-effective and scalable when compared to specialized pressure or airflow sensors.

Contemplated application include, but are not limited to using 3D printing to customize patient-specific designs for this project, which could lead to personalized healthcare and monitoring. Cilia-based sensors to read braille perceptively and accurately can be invaluable for the visually impaired, and in robotics.

Additionally, implantable cilia-based eyelashes to detect and trigger debris removal could provide effective therapeutics for those with alopecia or in the robotic debris removal could provide effective therapeutics for those with alopecia or in the robotic protection of sensitive camera lenses.

Th disclosed cilia-based sensing mechanism provides numerous opportunities for 3D-printed, next-generation mechanosensing, applicable to a wide range of disciplines, from environmental studies to the automotive industry, medical rehabilitation, and industrial maintenance.

It will be understood that when an element is referred to as being “connected” or “coupled” to another element, it can mean directly connected or coupled to the other element or intervening elements may be present. In contrast, when an element is referred to as being “directly connected” or “directly coupled” to another element, there may be no intervening elements present.

It is noted that, as used herein and in the appended claims, the singular forms “a”, “an”, and “the” include plural referents unless the context clearly dictates otherwise. It is further noted that the claims may be drafted to exclude any optional element. As such, this statement is intended to serve as support for the recitation in the claims of such exclusive terminology as “solely,” “only” and the like in connection with the recitation of claim elements, or use of a “negative” limitations, such as “wherein [a particular feature or element] is absent”, or “except for [a particular feature or element]”, or “wherein [a particular feature or element] is not present (included, etc.) . . . ”.

Where a range of values is provided, it is understood that each intervening value, to the tenth of the unit of the lower limit unless the context clearly dictates otherwise, between the upper and lower limit of that range and any other stated or intervening value in that stated range is encompassed within the invention. The upper and lower limits of these smaller ranges may independently be included in the smaller ranges and are also encompassed within the invention, subject to any specifically excluded limit in the stated range. Where the stated range includes one, or both of the limits, ranges excluding either or both of those included limits are also included in the invention.

As will be apparent to those of skill in the art upon reading this disclosure, each of the individual embodiments described and illustrated herein has discrete components and features which may be readily separated from or combined with the features of any of the other several embodiments without departing from the scope or spirit of the present invention. Any recited method can be carried out in the order of events recited or in any other order which is logically possible.

We claim:

1. An artificial conductive cilia based sensor, comprising:
a substrate;
a conductive pad and a neighbor conductive pad positioned a spacing distance, in a spacing direction, from the conductive pad, each secured to the substrate;
a first conductive cilium, having a distal end, a base end conductively secured to the conductive pad, and configured with a structural elasticity and bendable;
a second conductive cilium, having a respective base end conductively secured to the neighbor conductive pad;
a first terminal, supported on the substrate and comprising a first conductor electrically connected to the conductive pad; and
a second terminal, supported on the substrate and comprising a second conductor electrically connected to the neighbor conductive pad,
wherein
the first conductive cilium is further configured to bend, responsive to receiving a bending force directed in the spacing direction, to a bent state at which the distal end has a conductive path to the second conductive cilium and, responsive to removing said bending force, to return via a force from the structural elasticity to a relaxed shape that substantially reduces or terminates said conductive path.

2. The artificial cilia based sensor of claim 1, wherein
that first conductive cilium is further configured as bendable according to a bending sensitivity, and
the bending sensitivity and the spacing distance are mutually configured such that the first conductive cilium, in the bent state responsive to receiving the bending force, establishes the conductive path as a physical contact of the distal end of the first conductive cilium with the second conductive cilium.

3. The artificial cilia based sensor of claim 1, wherein
the first conductive cilium and the second conductive cilium are further configured as capable of concurrent immersion in a fluid having electrolytes,
the first conductive cilium is further configured as bendable according to a bending sensitivity and to receive the bending force from a flow of the liquid having electrolytes,
in the relaxed state the distal end of the first conductive cilium is separated from the second conductive cilium by a default path through the liquid having a default length,
the bending sensitivity and the spacing distance are mutually configured in a manner such that, in the bent state responsive to receiving the bending force from the flow of the liquid, the path through the liquid from the distal end to the second conductive cilium has a shortened length, less than the default length, having a shortened path conductance greater than the default conductance.

4. The artificial cilia based sensor of claim 3, further comprising:
a conductance measurement device, configured to measure a conductance from the first terminal to the second terminal, and to generate a corresponding measured conductance value, and
a flow measurement processor, configured to convert the measured conductance value to a flow measurement, or to generate, based at least in part on a time history of the measured conductance value, a flow versus time data, or both.

5. The artificial cilia based sensor of claim 1, wherein the distal end of the first conductive cilium comprises a distal tip and, conductively secured to the distal tip, a conductive cap.

6. The artificial cilia based sensor of claim 1, wherein:
the bent state is a first cilium bent state,
the first conductive cilium is further configured as bendable according to a bending sensitivity, and the structural elasticity is a first cilium elasticity that is configured to bias the first conductive cilium toward a first cilium relaxed shape,
the second conductive cilium is further configured as bendable according to a second bending sensitivity and has a second cilium elasticity that biases the second conductive cilium toward a second cilium relaxed shape,
the first cilium bent shape is spatially displaced from the first cilium relaxed shape by a first cilium displacement,
in a condition wherein the bending force acts in the spacing direction, concurrently on the first conductive cilium and the second conductive cilium, the second conductive cilium bends to a second cilium bent state that is spatially displaced from the second cilium relaxed shape by a second cilium displacement,
the first bending sensitivity is greater than the second bending sensitivity by a sensitivity difference, and based at least in part on the sensitivity difference, the first cilium displacement is greater than the second cilium displacement, by a net displacement,
based at least in part on the net displacement, a combination state of the first cilium bent state and the second cilium bent shape establishes a net displacement conductive path from the distal end of the first conductive cilium to the second conductive cilium, and
responsive to a removing said bending force, a combination of the first cilium elasticity bias of the first conductive cilium and the second cilium elasticity bias of the second conductive cilium to the second cilium relaxed state substantially reduces a conductivity of or terminates said net displacement conductive path.

7. The artificial cilia based sensor of claim 1, wherein
the conductive pad is a first conductive pad among a plurality of first conductive pads that are secured to the substrate,
the neighbor conductive pad is a second conductive pad among a plurality of second conductive pads that are secured to the substrate,
the first conductive cilium is among a plurality of first conductive cilia, each comprising a respective base end conductively secured to a respective first conductive pad among the plurality of first conductive pads, each configured as bendable according to a respective first cilia bending sensitivity, and
the second conductive cilium is among a plurality of second conductive cilia, each comprising a respective base end conductively secured to a respective second conductive pad among the plurality of second conductive pads, each configured as bendable according to a respective second cilia bending sensitivity.

8. The artificial cilia based sensor of claim 7, wherein at least a sub-plurality of the first conductive cilia and at least a sub-plurality of the second conductive cilia comprise graphene dispersed in a polymer matrix.

9. The artificial cilia based sensor of claim 7, wherein at least a sub-plurality of the first conductive pads comprise silver and at least a sub-plurality of the second conductive pads comprise silver.

10. The artificial cilia based sensor of claim 7, wherein the substrate comprises a flexible tape substrate body.

11. The artificial cilia based sensor of claim 7, wherein:
each of at least a sub-plurality of the first conductive pads are according to a first conductive cup structure, comprising a respective first configuration cup-shaped surface that faces away from the substrate and is configured to support vertical solvent casting printing of a respective first conductive cilium among the plurality of first conductive cilia, and
each of at least a sub-plurality of the second conductive pads are according to a second conductive cup structure, comprising a respective second configuration cup-shaped surface that faces away from the substrate and is configured to support vertical solvent casting printing of a respective second conductive cilium among the plurality of second conductive cilia.

12. The artificial cilia based sensor of claim 7, further comprising a rubber dermal layer disposed above the substrate, and configured to surround the respective conductive securements of the base ends of the first conductive cilia to the first conductive pads, and to surround respective conductive securements of the base ends of the second conductive cilia to the second conductive pads.

13. The artificial cilia based sensor of claim 7, wherein:
the first bending sensitivity is greater than the second bending sensitivity, by a difference,
the difference has a magnitude such that, in a condition in which a force having a force direction and a force magnitude above a force threshold, acting on the first conductive cilia and the second conductive cilia, produces respective bendings of the first conductive cilia and respective lesser bendings of the second conductive cilia.

14. The artificial cilia based sensor of claim 13,
responsive to the force direction being a first direction, the lesser bending by the adjacent second conductive cilium is less than the bending by the first conductive cilium by an amount that produces a forward net effect, the forward net effect being a movement of the distal end of the particular first conductive cilium in a direction toward the adjacent second conductive cilium, and
responsive to the force direction being a second direction, the lesser bending by the adjacent second conductive cilium produces a reverse net effect, the reverse net effect being a movement of the distal end of the particular first conductive cilium in a direction away from the adjacent second conductive cilium.

15. The artificial cilia based sensor of claim 14, wherein:
the distal end of at least the first conductive cilium comprises a distal tip and, conductively secured to the distal tip, a conductive cap, and
responsive to the force being in the first direction, with the force magnitude being above a pre-determined level, the produced forward net effect is of a magnitude such that the conductive cap contacts the adjacent second conductive cilium.

16. A method, comprising:
printing, on a substrate:
a conductive pad and a neighbor conductive pad, spaced apart with a spacing direction and spacing distance,
a first terminal, comprising a first conductor electrically connected to the conductive pad, and a second terminal, comprising a second conductor electrically connected to the neighbor conductive pad; and
three-dimensional (3D) vertical printing a first conductive cilium on the conductive pad and a second conductive cilium on the second conductive pad, wherein:
the 3D vertical printing each 3D vertical printing comprises a solvent casting 3D printing that includes extruding a homogenous paste comprising graphene, a polymer, and solvent, through an extrusion tip, while continually elevating the extrusion tip, and
the solvent casting 3D printing includes a parameter having a first value in the 3D vertical printing the first conductive cilium and a second value in the 3D vertical printing the second conductive cilium, the first value being configured to provide the first conductive cilium a first bending sensitivity and the second value being configured to provide the second conductive cilium a second bending sensitivity, lower than the first bending sensitivity.

17. The method claim 16, wherein the printing on the substrate is configured to print, using a microparticle ink comprising silver:
the conductive pad as a first conductive cilium supporting first silver conductive pad,
the neighbor conductive pad as a second conductive cilium supporting second silver conductive pad,
the first terminal as a silver first terminal pad and a silver first conductor trace electrically connecting the silver first terminal pad to the first conductive cilium supporting first silver conductive pad, and
the second terminal as a silver second terminal pad and a silver second conductor trace electrically connecting the silver second terminal pad to the second conductive cilium supporting second silver conductive pad.

18. The method claim 17, wherein the printing on the substrate is configured to print, using the microparticle ink comprising silver:
the first conductive cilium supporting first silver conductive pad as a first silver cup structure, comprising a respective first configuration cup-shaped surface that faces away from the substrate and is configured to the support the vertical solvent casting printing the first conductive cilium, and
the second conductive cilium supporting second silver conductive pad as a second silver cup structure, comprising a respective second configuration cup-shaped surface that faces away from the substrate and is configured to the support the vertical solvent casting printing the second conductive cilium.

19. The method claim 18, wherein:
the solvent casting 3D printing the first conductive cilium is configured to form the first conductive cilium with a first cilium diameter,
the solvent casting 3D printing the second conductive cilium is configured to form the second conductive cilium with a second cilium diameter, which is larger than the first cilium diameter,
the respective first configuration cup-shaped surface comprises a first cup diameter in accordance with the first cilium diameter, and
the respective second configuration cup-shaped surface comprises a second cup diameter, which is larger than the first cup diameter and in accordance with the second cilium diameter.
